(19) United States
(12) Patent Application Publication
(10) Pub. No.: US 2017/0236188 A1
(43) Pub. Date: Aug. 17, 2017

(54) SYSTEM AND METHOD FOR AUTOMATING BUSINESS PROCESSES THROUGHOUT THE LIFE CYCLE OF AN ORDER BY USING A PUBLISH-SUBSCRIBER PATTERN

(71) Applicant: NETSUITE INC., SAN MATEO, CA (US)

(72) Inventors: PATRICK PUCK, ALELLA (ES); ALBERT MARGARIT GRANERO, BARCELONA (ES); KRZYSZTOF SLUPSKI, BARCELONA (ES); TAO KOÏCHI SERGE KLERKS, MADRID (ES)

(21) Appl. No.: 14/979,242

(22) Filed: Dec. 22, 2015

Related U.S. Application Data
(60) Provisional application No. 62/097,864, filed on Dec. 30, 2014.

(51) Int. Cl. G06Q 30/06

(52) U.S. Cl. CPC G06Q 30/0635

(57) ABSTRACT

Systems, apparatuses, and methods for more efficiently providing and implementing order management and order processing services to one or more tenants of a multi-tenant business data processing platform. In one embodiment, processes, sub-processes, or functions within a larger order processing system may participate in an implementation of a subscriber-publisher protocol, wherein processes, sub-processes, or functions “publish” notifications and/or related information about “events” for consumption by subscribing processes, sub-processes, or functions. The subscribing processes, sub-processes, or functions may then use information about an event to trigger a related or dependent aspect of the order processing system

### CROSS REFERENCE TO RELATED APPLICATION

This application claims priority from U.S. provisional patent application No. 62/097,864, entitled “System and Method for Automating Business Processes Throughout the Life Cycle of an Order by Using a Publish-Subscriber Pattern,” filed Dec. 30, 2014, which is incorporated by reference herein in its entirety (including the Appendix) for all purposes.

### BACKGROUND

Order management and order processing functions are an important part of any product or service provider's business operations. Once an order is received a business may have multiple business processes that must be executed in order to process the order, fulfill the order, ship and deliver the order, and complete the processing of payment for the order. Retailers (whether brick and mortar, or eCommerce based) generally prefer to have a relatively high degree of automation for processing received order transactions through the various stages of the life cycle of an order (such as order capture, inventory evaluation, payment processing, pick/pack/ship, returns, credits, billing, etc.). This enables a smoother and more efficient processing and fulfillment of orders, and hence higher throughput and reliability (which may contribute to profit margin and other desirable aspects of a business).

However, throughout these various stages of processing and fulfilling an order, decisions may need to be made and certain business processes may need to be triggered, where many of these decisions or processes may be based on a specific merchant's preferences or current operating circumstances. Thus, a merchant desires an automated, but customizable, set of processes for order processing and fulfillment, where those processes can be modified as needed to take into account the merchant's specific operating conditions and business rules (where such operating conditions and rules may change over time as part of a business cycle or in response to certain external events).

Conventional approaches to the automation and control of order management and processing functions typically rely on a set of defined workflows and typically lack the ability for user configuration or reconfiguration of the relationships between order-related events (order placement, payment, fulfillment) and specific business processes, particularly those that may change due to changes in operating conditions or the competitive environment. The relevant business processes may be a function or sub-process that is part of a payment processing or order fulfillment operation, a process to update inventory records, a specific way of authorizing a payment transaction for certain high value items, etc. This makes such conventional approaches of limited value to merchants that are operating in a dynamic environment, such as one in which business conditions or goals are changing over time (or at least on a timeframe that is less than that which might justify a revision of the set of workflows). Embodiments of the invention are directed toward solving these and other problems individually and collectively.

### SUMMARY

The terms “invention,” “the invention,” “this invention” and “the present invention” as used herein are intended to refer broadly to all of the subject matter described in this document and to the claims. Statements containing these terms should be understood not to limit the subject matter described herein or to limit the meaning or scope of the claims. Embodiments of the invention covered by this patent are defined by the claims and not by this summary. This summary is a high-level overview of various aspects of the invention and introduces some of the concepts that are further described in the Detailed Description section below. This summary is not intended to identify key, required, or essential features of the claimed subject matter, nor is it intended to be used in isolation to determine the scope of the claimed subject matter. The subject matter should be understood by reference to appropriate portions of the entire specification of this patent, to any or all drawings, and to each claim.

Embodiments of the invention are directed to systems, apparatuses, and methods for more efficiently providing and implementing order management and order processing services to one or more tenants of a multi-tenant business data processing platform. In one embodiment, processes, sub-processes, or functions within a larger order processing system may participate in an implementation of a subscriber-publisher protocol, wherein processes, sub-processes, or functions “publish” notifications and/or related information about “events” for consumption by subscribing processes, sub-processes, or functions. The subscribing processes, sub-processes, or functions may then use information about an event to trigger a related or dependent aspect of the order processing system. This architecture can be used to make an order processing system more closely aligned with other business events or processes that may vary on a relatively short timescale (such as business goals, fulfillment options, inventory levels, etc.), providing a dynamic and more flexible option to the operation of conventional systems.

In some embodiments of the inventive system and methods, the triggered aspect may be an operation, process, function, stage, event, or other relevant response, and may be determined by a suitable decision process. Such a decision process may be based on a rule set, a comparison, a logical evaluation, or other relevant method. For example, a decision process may be a function of one or more dynamic variables or parameters that are representative of a state of the business. These dynamic variables or parameters may include, but are not limited to, inventory level, revenue, profit margin, inventory location, fulfillment status, percentage of sales goal met, or another business related measurement or metric. The variables or parameters used in a decision process may be specified by a user and/or identified by application of a suitable data analysis technique such as machine learning, pattern matching, statistical analysis, etc., while the values of one or more of those variables or parameters may be obtained from the data for a specific account that is maintained on a business data processing platform.

As noted, in some embodiments, the inventive methods may be implemented as part of or in conjunction with a business data processing system or platform. The business data processing system or platform may be a multi-tenant cloud-based system or platform used to store tenant data and process that data using one or more business related applications, where such applications may include ERP, CRM, eCommerce, financial, or HR related applications.

In one embodiment, the invention is directed to a system for automating the execution of a business process, where the system includes:
a computer-implemented process to permit a user to specify the business process, and one or more business objects that are associated with the business process;
a computer-implemented process to permit the user to specify an event that is to be generated by the business process upon the detection and/or processing of one or more of the one or more business objects;
a computer-implemented process to permit the user to specify a second business process that is to be configured to detect the generated event; and
a computer-implemented process to permit the user to specify an action or inaction by the second business process in response to the detected event.

In another embodiment, the invention is directed to a multi-tenant business data processing system, where the system includes:
one or more business related data processing applications installed in the system and accessible by a plurality of tenants of the multi-tenant data processing system;
a data storage element coupled to the one or more business related data processing applications;
a processor programmed with a set of instructions, wherein when executed by the processor, the instructions cause the system to
permit a user to specify a business process, and one or more business objects that are associated with the business process;
permit the user to specify an event that is to be generated by the business process upon the detection and/or processing of one or more of the one or more business objects;
permit the user to specify a second business process that is to be configured to detect the generated event; and
permit the user to specify an action or inaction by the second business process in response to the detected event.

Other objects and advantages of the present invention will be apparent to one of ordinary skill in the art upon review of the detailed description of the present invention and the included figures.

### BRIEF DESCRIPTION OF THE DRAWINGS

Embodiments of the invention in accordance with the present disclosure will be described with reference to the drawings, in which:

FIG. 1 is a diagram illustrating a system, including an integrated business system and an enterprise network in which an embodiment of the invention may be implemented;

FIG. 2 is a diagram illustrating elements or components of an example operating environment in which an embodiment of the invention may be implemented;

FIG. 3 is a diagram illustrating additional details of the elements or components of the multi-tenant distributed computing service platform of FIG. 2, in which an embodiment of the invention may be implemented;

FIG. 4(a) is a diagram illustrating aspects of a publisher-subscriber communications protocol that may be used when implementing an embodiment of the invention;

FIG. 4(b) is a diagram illustrating aspects of a system, process, method, operation, or function for automating certain business processes associated with order management or order processing, and that may be used when implementing an embodiment of the invention;

FIG. 5 is an example of a data domain model that may be used as part of implementing an embodiment of the inventive system and methods;

FIG. 6 is a flow chart or flow diagram illustrating a process or event flow that may be implemented in an embodiment of the inventive system and methods;

FIG. 7 is a diagram illustrating the process flow of an example of the wave mode of events handling that may be implemented in an embodiment of the inventive system and methods;

FIG. 8 is a diagram illustrating the process flow of an example of the streamed mode of events handling that may be implemented in an embodiment of the inventive system and methods; and

FIG. 9 is a diagram illustrating elements or components that may be present in a computer device or system configured to implement a method, process, function, or operation in accordance with an embodiment of the invention.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will satisfy the statutory requirements and convey the scope of the invention to those skilled in the art.

Among other things, the present invention may be embodied in whole or in part as a system, as one or more methods, or as one or more devices. Embodiments of the invention may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, etc.) that are part of a client device, server, network element, or other form of computing or data processing device/platform and that are programmed with a set of executable instructions (e.g., software instructions), where the instructions may be stored in a suitable data storage element. In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

Prior to describing one or more embodiments of the inventive system and methods in greater detail, it is noted that the following terms or concepts have at least the indicated meaning when used in the context of the invention:
Business Events—records that describe an action that occurred as a result of a business process within a data processing platform. Such an event could be a trigger, for example “Sales Order Created”;
Business Event Handler—handlers are encapsulated business logic that is triggered by a business event or events. This would typically be the reactor to a trigger, for example “Evaluate (the created) Sales Order for Fulfillment”;
Event Stream—this describes the processing or handling of events in a continuous, near real-time fashion. Note that this is in contrast to an event wave (as described herein), which refers to a different processing scheme. The processing of event streams is performed by the “Event Manager” element or process; and
Event Wave—this describes the processing or handling of events in a scheduled, timed batch-type fashion. The processing of event waves is performed by the “Event Organizer” element or process.

Embodiments of the present invention are directed to systems, apparatuses, and methods for automating certain aspects of the order processing operations of a business. In one embodiment, processes, sub-processes, or functions within a larger order processing system may participate in an implementation of a subscriber-publisher protocol, wherein processes, sub-processes, or functions “publish” notifications and/or related information about “events” for consumption by subscribing processes, sub-processes, or functions. The subscribing processes, sub-processes, or functions may then use information about an event to trigger or initiate a related or dependent aspect of the order processing system.

The triggered/initiated aspect may be an operation, process, function, stage, event, or other relevant response, and may be determined in accordance with a suitable decision process. Such a decision process may be based on a rule set, a comparison process, a logical evaluation, a mathematical model, or other relevant method. For example, a decision process may be a function of one or more dynamic variables or parameters that are representative of a state of the business. These dynamic variables or parameters may include, but are not limited to, inventory level, revenue, profit margin, inventory location, fulfillment status, a percentage of a business goal achieved, or another business related measurement or metric. The variables or parameters used in a decision process may be specified by a user and/or identified by application of a suitable data analysis technique such as machine learning, pattern matching, statistical analysis, etc.

Embodiments of the inventive architecture permit a high degree of business or user customization and the capacity for dynamic adaptation of the overall order processing system to the state of (or changes in the state of) a business' operations (such as might be reflected by data or parameter values contained in an Enterprise Resource Planning (ERP), Customer relationship Management (CRM), eCommerce, Human Resources (HR), or other business related system of sub-system). Note that in some embodiments, the inventive system, architecture, and methods may be implemented (in whole or in part) as part of a different type of business system, such as a financial management or accounting system (e.g., for purposes of reconciling accounting books, determining cash-flow projections, generating invoices, etc.), inventory management system (e.g., for purposes of managing inventory levels, ordering supplies, tracking shipments, etc.), etc.

Such an extension or adaptation of the methods and concepts that form part of the inventive system may be possible in situations in which a system or process has, or can be modified to have the following characteristics:
A user may configure one or more process steps or stages to initiate an event notification, wherein a message or data packet is generated and made available for “reception” or detection by a monitoring element;
   In some embodiments, the initiation of the event notification may be conditioned on one or more rules, parameters, the occurrence of specified data values, system states, specific business related data, etc.;
A user may configure one or more process steps or stages to be monitoring or actively “listening” to detect an event notification that is generated by a specified event, combination of events, or (sub)process;
   In some embodiments, the active monitoring may be conditioned on one or more rules, parameters, the occurrence of specified data values, system states, specific business related data, etc.; and
A user may configure the action or reaction of the overall system or of a component element or (sub)process of the system to the detected event notification, where such action or reaction (or inaction) may include, but is not limited to initiating a (sub)process step or stage, altering a previously configured (sub)process step or stage, pausing or delaying a (sub)process step or stage, generating new data, generating a notification or message, updating data in a file, directory, or database, erasing certain data, maintaining an existing state or status, etc.;
   In some embodiments, the action or reaction (or inaction) may be conditioned on one or more rules, parameters, the occurrence of specified data values, system states, specific business related data, etc.
      As an example, an embodiment of the inventive methods may be applied to a system such as a transportation network (wherein the motion of a vehicle is altered based on the detection of certain signals, and each vehicle functions as an entity that monitors messages from other vehicles, signaling devices, route indicators, a central control facility, etc.). Further examples include data networks (where each node functions as a potential emitter of event related data and as a monitor of messages emitted by other nodes, and where message or data transfer may be conditioned on system capacity, current data transfer rates, a node's status, etc.), and the control of complex machinery that is used as part of a manufacturing process (where each substantial function element in the machine being used functions as a potential emitter of event related data and as a monitor of messages emitted by other elements).

In embodiments of the inventive system and methods, messages are modeled as events, publishers of events are defined within the business logic of the system, and receivers of events are represented by business processes. The interaction between events, business logic, and business processes is enabled by use of a publisher/subscriber protocol, thereby providing benefits to the operation of a multi-tenant system in terms of resource allocation and user customization.

For example, in a multi-tenant system, application of the protocol provides users with the flexibility to model business flows on a per tenant basis. In contrast, business workflows are typically fixed and more rigid in conventional systems, where business logic causes a triggering of subsequent actions based on the state of the system. However, in multi-tenant environments, the set of workflows within a system can become extremely complex because each tenant desires to model their business workflows in different ways to fit their respective business or operational needs. This means that business logic that is based on system state may not have sufficient flexibility to provide individual tenants with a desired level of control over their own workflow (which may vary in accordance with specific data or events). By applying the publish-subscription model between business events and business processes described herein, business flows are no longer as rigid or static and can be modified on a per-tenant basis (and in some cases, on a per-transaction state or other dynamic basis).

Further, in a multi-tenant system, tenants typically have different expectations and needs in terms of system load, performance, and data processing throughput. In conventional systems, scaling the throughput and response time of business processes efficiently becomes a challenge since the relationship between business processes is tightly coupled to the business logic of a specific data processing application. This makes scaling business processes to meet each tenant's needs (which may change depending on that tenant's business, external events, etc.) in a system whose business processes are tightly coupled relatively complex. As a result, in conventional systems the approach used to scale coupled subsystems is by replicating the whole system. This approach increases the total throughput of the whole system; however, this type of scalability solution does not address any of the per-tenant scalability needs (which may vary between tenants and over time for the same tenant).

The proposed inventive system and methods define a clear line between events, processes and interactions for each tenant account, enabling an independent dynamic scalability solution for each tenant. For example, embodiments of the inventive system permit dynamically replicating tenant-specific business processes that are heavily used by a tenant that is experiencing a high volume of business events due to a peak period, because of the relative size of the tenant in the system, or for another tenant-specific reason.

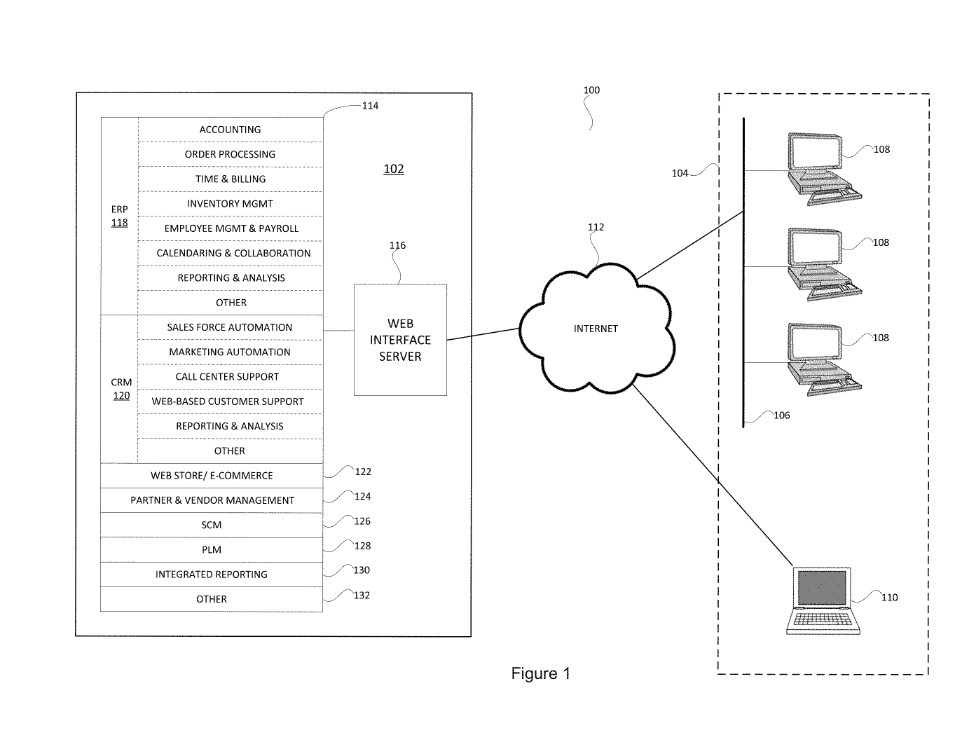

As noted, in some embodiments, the invention may be implemented in the context of a multi-tenant, “cloud” based environment (such as a multi-tenant business data processing platform), typically used to develop and provide web services, store business related data and enable the processing of that data using business applications (such as Enterprise Resource Planning, Customer Relationship Management, eCommerce, Financial, Human Resources Management, etc.). This exemplary implementation environment will be described with reference to FIGS. 1-3). Note that embodiments of the invention may also be implemented in the context of other computing or operational environments or systems, such as for an individual business data processing system, a private network used with a plurality of client terminals, a remote or on-site data processing system, another form of client-server architecture, etc.

Modern computer networks incorporate layers of virtualization so that physically remote computers and computer components can be allocated to a particular task and then reallocated when the task is done. Users sometimes speak in terms of computing “clouds” because of the way groups of computers and computing components can form and split responsive to user demand, and because users often never see the computing hardware that ultimately provides the computing services. More recently, different types of computing clouds and cloud services have begun emerging.

For the purposes of this description, cloud services may be divided broadly into “low level” services and “high level” services. Low level cloud services (sometimes called “raw” or “commodity” services) typically provide little more than virtual versions of a newly purchased physical computer system: virtual disk storage space, virtual processing power, an operating system, and perhaps a database such as an RDBMS. In contrast, high or higher level cloud services typically focus on one or more well-defined end user applications, such as business oriented applications. Some high level cloud services provide an ability to customize and/or extend the functionality of one or more of the end user applications they provide; however, high level cloud services typically do not provide direct access to low level computing functions.

The ability of business users to access crucial business information has been greatly enhanced by the proliferation of IP-based networking together with advances in object oriented Web-based programming and browser technology. Using these advances, systems have been developed that permit web-based access to business information systems, thereby allowing a user with a browser and an Internet or intranet connection to view, enter, or modify business information. For example, substantial efforts have been directed to Enterprise Resource Planning (ERP) systems that integrate the capabilities of several historically separate business computing systems into a common system, with a view toward streamlining business processes and increasing efficiencies on a business-wide level. By way of example, the capabilities or modules of an ERP system may include (but are not required to include, nor limited to only including): accounting, order processing, time and billing, inventory management, employee management/payroll, human resources management, and employee calendaring and collaboration, as well as reporting and analysis capabilities relating to these functions.

In a related development, substantial efforts have also been directed to integrated Customer Relationship Management (CRM) systems, with a view toward obtaining a better understanding of customers, enhancing service to existing customers, and acquiring new and profitable customers. By way of example, the capabilities or modules of a CRM system can include (but are not required to include, nor limited to only including): sales force automation (SFA), marketing automation (including marketing campaign automation), contact list, call center support, and web-based customer support, as well as reporting and analysis capabilities relating to these functions. With differing levels of overlap with ERP/CRM initiatives and with each other, efforts have also been directed toward development of increasingly integrated partner and vendor management systems, web store/eCommerce systems, product lifecycle management (PLM) systems, and supply chain management (SCM) systems.

FIG. 1 is a diagram illustrating a system 100, including an integrated business system 102 and an enterprise network 104 in which an embodiment of the invention may be implemented. Enterprise network 104 may be associated with a business enterprise, such as a retailer, merchant, service provider, or other type of business. Alternatively, and in accordance with the advantages of an application service provider (ASP) hosted integrated business system (such as a multi-tenant data processing platform), the business enterprise may comprise fewer or no dedicated facilities or business network at all, provided that its end users have access to an internet browser and an internet connection. For simplicity and clarity of explanation, the enterprise network 104 is represented by an on-site local area network 106 to which a plurality of personal computers 108 are connected, each generally dedicated to a particular end user (although such dedication is not required), along with an exemplary remote user computer 110 that can be, for example, a laptop computer or tablet computer of a traveling employee having internet access through a hotel, coffee shop, a public Wi-Fi access point, or other internet access method. The end users associated with computers 108 and 110 may also (or instead) possess an internet-enabled smartphone or other electronic device (such as a PDA) having wireless internet access or other synchronization capabilities. Users of the enterprise network 104 interface with the integrated business system 102 across the Internet 112 or another suitable communications network or combination of networks.

Integrated business system 102, which may be hosted by a dedicated third party, may include an integrated business server 114 and a web interface server 116, coupled as shown in FIG. 1. It is to be appreciated that either or both of the integrated business server 114 and the web interface server 116 may be implemented on one or more different hardware systems and components, even though represented as singular units in FIG. 1. In one embodiment, integrated business server 114 comprises an ERP module 118 and further comprises a CRM module 120. In many cases, it will be desirable for the ERP module 118 to share methods, libraries, databases, subroutines, variables, etc., with CRM module 120, and indeed ERP module 118 may be intertwined with CRM module 120 into an integrated Business Data Processing Platform (which may be single tenant, but is typically multi-tenant).

The ERP module 118 may include, but is not limited to, a finance and accounting module, an order processing module, a time and billing module, an inventory management and distribution module, an employee management and payroll module, a calendaring and collaboration module, a reporting and analysis module, and other ERP-related modules. The CRM module 120 may include, but is not limited to, a sales force automation (SFA) module, a marketing automation module, a contact list module (not shown), a call center support module, a web-based customer support module, a reporting and analysis module, and other CRM-related modules. The integrated business server 114 (or multi-tenant data processing platform) further may provide other business functionalities including a web store/eCommerce module 122, a partner and vendor management module 124, and an integrated reporting module 130. An SCM (supply chain management) module 126 and PLM (product lifecycle management) module 128 may also be provided. Web interface server 116 is configured and adapted to interface with the integrated business server 114 to provide one or more web-based user interfaces to end users of the enterprise network 104.

The integrated business system shown in FIG. 1 may be hosted on a distributed computing system made up of at least one, but likely multiple, “servers.” A server is a physical computer dedicated to supporting one or more software services/applications intended to serve the needs of the users of other computers that are in data communication with the server, for instance via a public network such as the Internet or a private “intranet” network. The server, and the services/applications it provides, may be referred to as the “host” and the remote computers being served (and the software applications running on the remote computers) may be referred to as “clients.” Depending on the computing service that a server offers it could be referred to as a database server, file server, mail server, print server, web server, etc. A web server is most often a combination of hardware and the software that helps deliver content, commonly by hosting a website, to client web browsers that access the web server via the Internet.

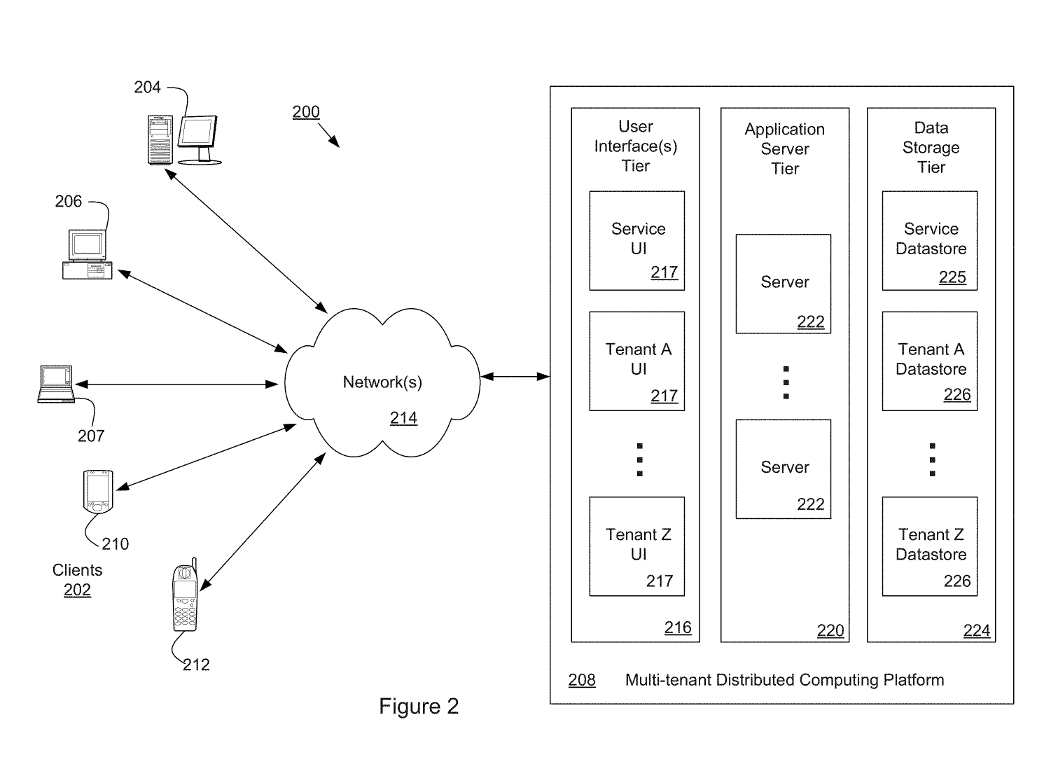

FIG. 2 is a diagram illustrating elements or components of an example operating environment 200 in which an embodiment of the invention may be implemented. As shown, a variety of clients 202 incorporating and/or incorporated into a variety of computing devices may communicate with a distributed computing service/platform 208 through one or more networks 214. For example, a client may incorporate and/or be incorporated into a client application (e.g., software) implemented at least in part by one or more of the computing devices. Examples of suitable computing devices include personal computers, server computers 204, desktop computers 206, laptop computers 207, notebook computers, tablet computers or personal digital assistants (PDAs) 210, smart phones 212, cell phones, and consumer electronic devices incorporating one or more computing device components, such as one or more electronic processors, microprocessors, central processing units (CPU), or controllers. Examples of suitable networks 214 include networks utilizing wired and/or wireless communication technologies and networks operating in accordance with any suitable networking and/or communication protocol (e.g., the Internet).

The distributed computing service/platform (which may also be referred to as a multi-tenant business data processing platform) 208 may include multiple processing tiers, including a user interface tier 216, an application server tier 220, and a data storage tier 224. The user interface tier 216 may maintain multiple user interfaces 217, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs). The default user interface may include components enabling a tenant (or platform administrator) to administer/manage the tenant's participation in the functions and capabilities provided by the service platform, such as accessing data, causing the execution of specific data processing operations, etc. Each processing tier shown in the figure may be implemented with a set of computers and/or computer components including computer servers and processors, and may perform various functions, methods, processes, or operations as determined by the execution of a software application or a set of executable instructions. The data storage tier 224 may include one or more data stores, which may include a Service Data store 225 and one or more Tenant Data stores 226.

Each tenant data store 226 may contain tenant-specific data that is used as part of providing a range of tenant-specific business services or functions, including but not limited to ERP, CRM, eCommerce, Human Resources management, financial accounting and modeling, payroll, etc. Data stores may be implemented with any suitable data storage technology, including structured query language (SQL) based relational database management systems (RDBMS).

In accordance with one embodiment of the invention, distributed computing service/platform 208 may be multi-tenant and service platform 208 may be operated by an entity in order to provide multiple tenants with a set of business related applications, data storage, and functionality. These applications and functionality may include ones that a business uses to manage various aspects of its operations. For example, the applications and functionality may include providing web-based access to business information systems, thereby allowing a user with a browser and an Internet or intranet connection to view, enter, process, or modify certain types of business information.

As noted, such business information systems may include an Enterprise Resource Planning (ERP) system that integrates the capabilities of several historically separate business computing systems into a common system, with the intention of streamlining business processes and increasing efficiencies on a business-wide level. By way of example, the capabilities or modules of an ERP system may include: accounting, order processing, time and billing, inventory management, employee management/payroll, and employee calendaring and collaboration, as well as reporting and analysis capabilities relating to these functions. Another business information system that may be provided as part of an integrated service platform is an integrated Customer Relationship Management (CRM) system, which is designed to assist in obtaining a better understanding of customers, enhance service to existing customers, and assist in acquiring new and profitable customers. By way of example, the capabilities or modules of a CRM system may include: sales force automation (SFA), marketing automation, contact list management, call center support, and web-based customer support, as well as reporting and analysis capabilities relating to these functions. In addition to ERP and CRM functions, a business information system/platform (such as element 208 of FIG. 2) may also include one or more of an integrated partner and vendor management system, eCommerce system (e.g., a virtual storefront application or platform), product lifecycle management (PLM) system, Human Resources management system (which may include medical/dental insurance administration, payroll, etc.), accounting, financial modeling, or supply chain management (SCM) system. Such functions, processes, or business applications are typically implemented by one or more modules of software code/instructions that are maintained on and executed by one or more servers 222 that are part of the platform's Application Server Tier 220.

Note that both functional advantages and strategic advantages may be gained through the use of an integrated business system comprising ERP, CRM, and other business capabilities, as for example where the integrated business system is integrated with a merchant's eCommerce platform and/or “web-store.” For example, a customer searching for a particular product can be directed to a merchant's website and presented with a wide array of product and/or services from the comfort of their home computer, or even from their mobile phone. When a customer initiates an online sales transaction via a browser-based interface, the integrated business system can process the order, update accounts receivable, update inventory databases and other ERP-based systems, and can also automatically update strategic customer information databases and other CRM-based systems. These modules and other applications and functionalities may advantageously be integrated and executed by a single code base accessing one or more integrated databases as necessary, forming an integrated business management system or platform (such as platform 208 of FIG. 2).

As noted with regards to FIG. 1, the integrated business system shown in FIG. 2 may be hosted on a distributed computing system made up of at least one, but typically multiple, “servers.” A server is a physical computer dedicated to supporting one or more software services/applications intended to serve the needs of the users of other computers that are in data communication with the server, for instance via a public network such as the Internet or a private “intranet” network. The server, and the services/applications it provides, may be referred to as the “host” and the remote computers being served (and the software applications running on the remote computers) may be referred to as “clients.”

Rather than build, administer, and maintain such an integrated business system themselves, a business may utilize a system provided by a third party. Such a third party (i.e., a platform operator, manager, or administrator) may implement an integrated business system/platform as described above in the context of a multi-tenant platform, wherein individual instantiations of a single comprehensive integrated business system are provided to a variety of tenants. One advantage to such multi-tenant platforms is the ability for each tenant to customize their instantiation of the integrated business system to that tenant's specific business needs or operational methods. Each tenant may be a business or entity that uses the multi-tenant platform to provide business data and functionality to multiple users, including customers and employees. Some of those multiple users may have distinct roles or responsibilities within the business or entity.

In some cases, a tenant may desire to modify or supplement the functionality of an existing platform application by introducing an extension to that application, where the extension is to be made available to the tenant's employees and/or customers. In some cases such an extension may be applied to the processing of one or more types of the tenant's business related data that is resident on the platform. The extension may be developed by the tenant or by a 3^{rd} party developer and then made available to the tenant for installation. The platform may include a “library” or catalog of available extensions, which can be accessed by a tenant and searched to identify an extension of interest. Software developers may be permitted to “publish” an extension to the library or catalog after appropriate validation of a proposed extension.

Thus, in an effort to permit tenants to obtain the services and functionality that they desire (which may include providing certain services to their end customers, such as in the case of an eCommerce platform), a multi-tenant service platform may permit a tenant to configure certain aspects of the available service(s) to better suit their business needs. In this way aspects of the service platform may be customizable, and thereby enable a tenant to configure aspects of the platform to provide distinctive services to their respective users or to groups of those users. For example, a business enterprise that uses the service platform may want to provide additional functions or capabilities to their employees and/or customers, or cause their business data to be processed in a specific way in accordance with a defined workflow that is tailored to their business needs, etc.

Tenant customizations to the platform may include custom functionality (such as the capability to perform tenant or user-specific functions, data processing, or operations) built on top of lower level operating system functions. Some multi-tenant service platforms may offer the ability to customize functions or operations at a number of different levels of the service platform, from aesthetic modifications to a graphical user interface to providing integration of components and/or entire applications developed by independent third party vendors. This can be very beneficial, since by permitting use of components and/or applications developed by third party vendors, a multi-tenant service can significantly enhance the functionality available to tenants and increase tenant satisfaction with the platform.

As noted, in addition to user customizations, an independent software developer may create an extension to a particular application that is available to users through a multi-tenant data processing platform. The extension may add new functionality or capabilities to the underlying application. One or more tenants/users of the platform may wish to add the extension to the underlying application in order to be able to utilize the enhancements to the application that are made possible by the extension.

Note that embodiments of the inventive system and methods may be used to define and cause the execution of a workflow that is account specific, user specific, role-specific, etc., and that includes processes or sub-processes that are initiated by events, data values, data trends, or other characteristics of a business' operation or operating environment. This permits a relatively high degree of customization and control between different users and accounts that are maintained on a multi-tenant data processing platform, while enabling those users and accounts to have the benefits of the multi-tenant architecture.

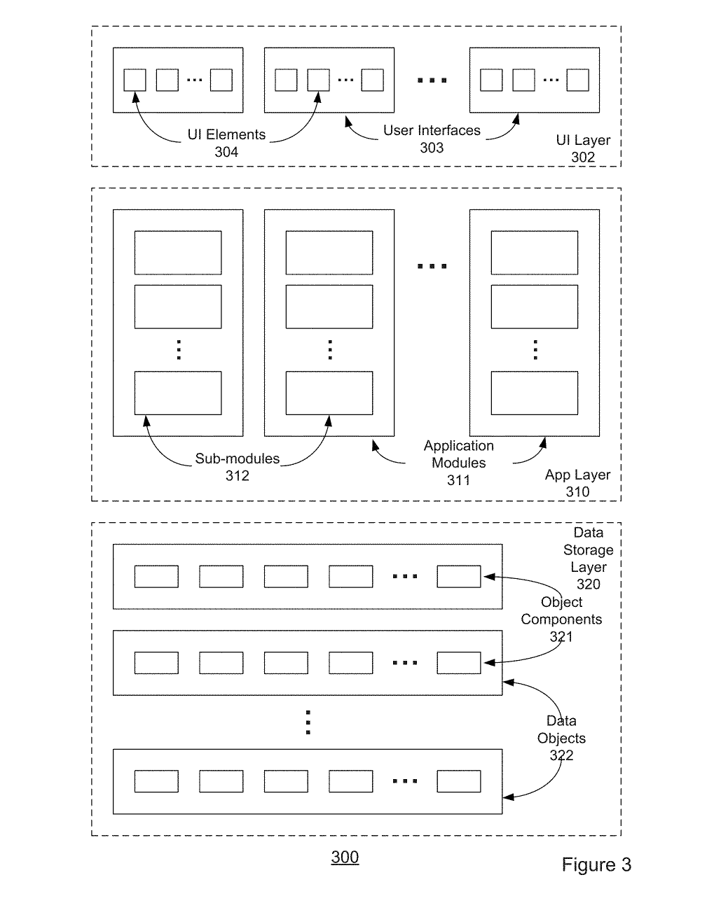

FIG. 3 is a diagram illustrating additional details of the elements or components of the multi-tenant distributed computing service platform of FIG. 2, in which an embodiment of the invention may be implemented. The software architecture depicted in FIG. 2 represents an example of a complex software system to which an embodiment of the invention may be applied. In general, an embodiment of the invention may be used in conjunction with a set of software instructions that are designed to be executed by a suitably programmed processing element (such as a CPU, microprocessor, processor, controller, computing device, server, platform, etc.). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 3 is a diagram illustrating additional details of the elements or components 300 of the multi-tenant distributed computing service platform of FIG. 2, in which an embodiment of the invention may be implemented. The example architecture includes a user interface layer or tier 302 having one or more user interfaces 303. Examples of such user interfaces include graphical user interfaces and application programming interfaces (APIs). Each user interface may include one or more interface elements 304. For example, users may interact with interface elements in order to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks and dialog boxes. Application programming interfaces may be local or remote, and may include interface elements such as parameterized procedure calls, programmatic objects and messaging protocols.

The application layer 310 may include one or more application modules 311, each having one or more sub-modules 312. Each application module 311 or sub-module 312 may correspond to a particular function, method, process, or operation that is implemented by the module or sub-module (e.g., a function or process related to providing ERP, CRM, eCommerce or other functionality to a user of the platform). Such function, method, process, or operation may also include those used to implement one or more aspects of the inventive system and methods, such as for:
Generating a suitable user interface to enable a user (such as a business owner or operator) to specify one or more operations or system functions that will be monitored for events—where the act of monitoring may depend upon one or more rules, criteria, thresholds, or conditions, and where such rules, criteria, thresholds, or conditions may depend in whole or in part on a value or values of business related data (e.g., sales, profit margin, current inventory, active sales leads, net profit, number of employees, etc.), and on static and/or dynamic data values;
Enabling a user to specify an event or events associated with an operation or system function, and indicate one or more actions/responses that are to be initiated for purposes of order management or order processing as a result of the occurrence or detection of the event or events (and if applicable, conditions, rules, parameters values, characteristics, etc. that if satisfied, will result in the initiation of the action/response);
Defining processes or operations to be executed for purposes of administration of, handling, and monitoring the execution of the action/response and/or the processing of events within a service platform;
Generating a suitable user interface to enable a user to monitor errors that might occur in system functions as a result of handling an event; and
Enabling a user to create custom events and determine which modules in an application will raise (trigger) them, and define the circumstances under which the event will be triggered.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 222 of FIG. 2) may include each application module. Alternatively, different application servers may include different sets of application modules. Such sets may be disjoint or overlapping.

The data storage layer 320 may include one or more data objects 322 each having one or more data object components 321, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 1-3 are not intended to be limiting examples. Alternatively, or in addition, computing environments in which an embodiment of the invention may be implemented include any suitable system that permits users to provide data to, and access, process, and utilize data stored in a data storage element (e.g., a database) that can be accessed over a network, where the computing service or platform is operable to process business related data (including, but not limited to inventory, financial, sales, marketing, and other business data). Further example environments in which an embodiment of the invention may be implemented in whole or in part include devices (including mobile devices), software applications, systems, apparatuses, networks, or other configurable components that may be used by multiple users for data entry, data processing, application execution, data review, etc. Although further examples below may reference the example computing environment depicted in FIGS. 1-3, it will be apparent to one of skill in the art that the examples may be adapted for alternate computing devices, systems, apparatuses, processes, and environments.

As further context for one or more embodiments of the inventive system and methods, it is noted that retailers typically capture thousands of orders per day and require systems that can automatically trigger business processes, with a goal of delivering products to the consumer as fast as possible with the least amount of human intervention. The business processes involved typically include the validation of payment information (e.g., to authorize a credit card account used for a purchase), validation of inventory levels (to confirm the ability to fulfill the order), determining the appropriate warehouse for fulfillment, keeping the consumer up to date on order status via email notifications, preparing the pick/pack/ship documents, generating and issuing an invoice, and completing the payment process upon successful shipment of the products or delivery of a service.

Typically, each of these (sub)processes must occur in a predetermined sequence, with one or more being triggered by a predetermined set of conditions or parameter values. The actual workflow of any given order or part of an order may depend on many different parameters and circumstances. Further, the configuration of an order workflow may be different for different businesses/retailers and may depend on one or more of the retailer's current methods of operation, real-time values of relevant business information, and/or specific business needs.

For example, depending upon the situation, which may be determined by one or more of season, inventory levels, profit margins, revenue stream, available labor, shipping cost, etc.:
(a) some retailers may not want to accept back orders at all;
(b) some retailers may want to obtain authorization from a payment account for the shippable amount before packing an order;
(c) some retailers may want to obtain authorization from a payment account for the entire amount when the order is placed;
(d) some retailers may want to re-try declined credit cards (i.e. continue to attempt to obtain authorization for a transaction) every other day;
(e) some retailers may want to optimize their shipping cost by shipping products together always, or under certain circumstances; or
(f) some retailers may want to optimize their shipping time by shipping from the closest warehouse, etc.

As a result of these and other possible variations, during the life cycle of an order, it may be controlled/driven by a set of business rules that interact with each other and create a complex network of possible paths that the order processing can flow through. As a result, given the variety of retailers and their different and varying operations or business concerns, it is not practical to define a decision tree that could satisfactorily accommodate the needs of the range of possible users. In contrast, embodiments of the invention provide an ability to abstract the business rules from the business processes, and thereby allow retailers to define actors, actions, reactors, reactions, and timing triggers/conditions to meet their individual business needs and modes of operation. In some embodiments, these customized workflows or data processing patterns may be dynamically variable, in that the steps or processes implemented may depend on the value of specific parameters or business characteristics that are stored on the data processing platform.

By implementing a business events processing framework based on a publisher/subscriber protocol (the operation and implementation of which are described in greater detail herein), embodiments of the invention operate to decouple business objects (e.g., a sales order) from a set of relevant business rules (e.g., validate the inventory, determine an optimal shipping route, authorize the payment, etc.) and business processes (e.g., pick, package and ship the order). In one embodiment of the inventive system and methods, the relationships between and configuration of business objects, business rules, and business processes is based on events (in the form of publishers, or information that is published) and event handlers (in the form of subscribers or elements that subscribe to specific publishers or sources of information). This structure and implementation allows each retailer (e.g., an account owner or tenant of a multi-tenant data processing service/platform) to adapt the automation of an order processing life cycle to their changing business needs and operational environment.

Note that the elements, operations, and functions described herein for purposes of business events processing related to orders may also be applied outside of the area of order management. Since the inventive framework is a generic framework to handle business events, objects, rules and processes, it may be applied to other business areas, such as revenue recognition, billing, and payments processing. These areas or functions also have business processes that can be triggered by decoupled events associated with invoices, purchase orders, credit card settlements, and employee events.

Note that the decoupling can have a time component, for example, when a credit card payment is declined, a “declined event” may be generated and may be subscribed to by a “reattempt process”. Additional features of the business events framework described herein allow users to specify a time component in the subscription to an event or publisher so that the reattempt process is triggered several days after the event has been generated. This is because it may not be beneficial to re-try a credit card operation such as an authorization immediately after it has been declined for the first time.

The decoupling concept or aspect of the inventive system can also be utilized by applying it to the relationship between areas of responsibility that raise the event (such as a Payment Decline event, managed in the Payments area) and to areas that subscribe to and act on an event (such as a Consumer Communication regarding risks of Shipping delays due to non-payment, in this case managed in the CRM area). This type of decoupling minimizes system rigidity in that neither area needs to be aware of any rules or constraints on the operation of the other.

The inventive system architecture and methods permit a high degree of business or user customization and the capacity for dynamic adaptation of the overall order processing system to the state (or to changes in the state) of a business. This means that the set of operations implemented for a business function (such as order processing) may be varied based on the desired process or workflow flow of a business. This customization could take the form of a specific subscription model, or be a set of custom events and/or custom process handlers defined by a user (or in some cases by a platform administrator).

In addition, in some embodiments, the conditions for generating a notification of an event or for the processing of an event may be made to depend on real-time (or pseudo real-time) values or changes in value of specific business related data, such as might be reflected by data contained in an Enterprise Resource Planning (ERP), Customer relationship Management (CRM), eCommerce, HR, financial, or other business related system or sub-system.

Further, as noted, in some embodiments, the inventive system, architecture, and methods may be implemented as part of a different type of business system, such as a financial management or accounting system (e.g., for purposes of reconciling accounting books, determining cash-flow projections, generating invoices, etc.), inventory management system (e.g., for purposes of managing inventory levels, ordering supplies, etc.), etc. Note also that while some processes might be configured to react directly to a specific business event, others might be configured to implement a delayed reaction. This is because in some situations, the processing of a set of business events may need to be strictly controlled so that the system infrastructure can handle the throughput and efficiently finalize the business key operations.

As noted, embodiments of the inventive system and methods utilize a publisher-subscriber communications and control protocol, where publisher-subscriber is a messaging pattern used in software architectures. The publisher-subscriber pattern may be used to address some of the problems involved in integrating multiple applications or components, while maintaining a clean and flexible architecture. Frequently, multiple modules or subsystems need to be integrated so that they can communicate effectively among themselves. However, as the total number of subsystems increases within a system, the complexity of integrating the subsystems and their communications paths increases exponentially. For example, in a system with a large number of subsystems, introducing a new one involves modifying all of the others so that they will recognize the new module and be able to establish communications.

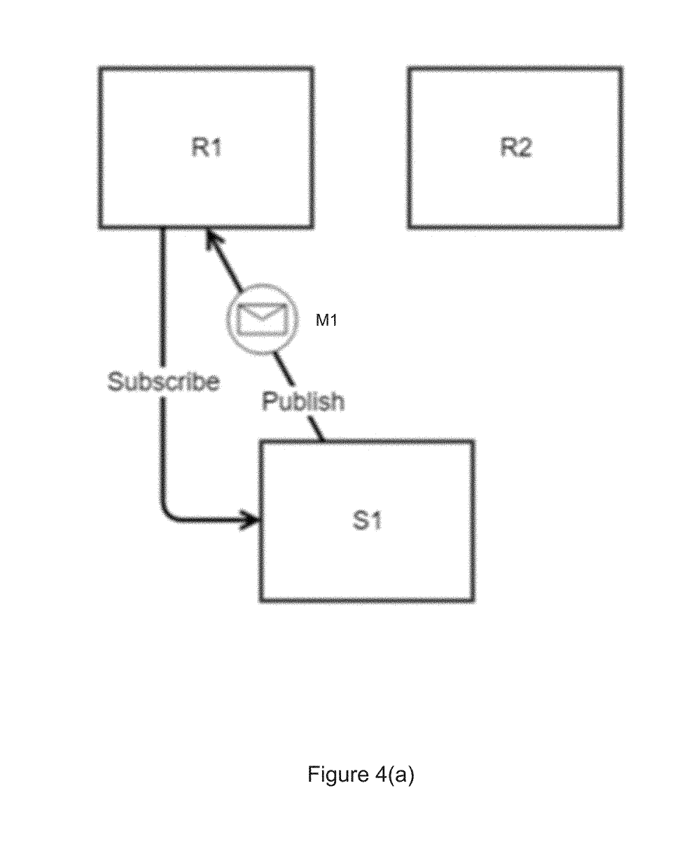

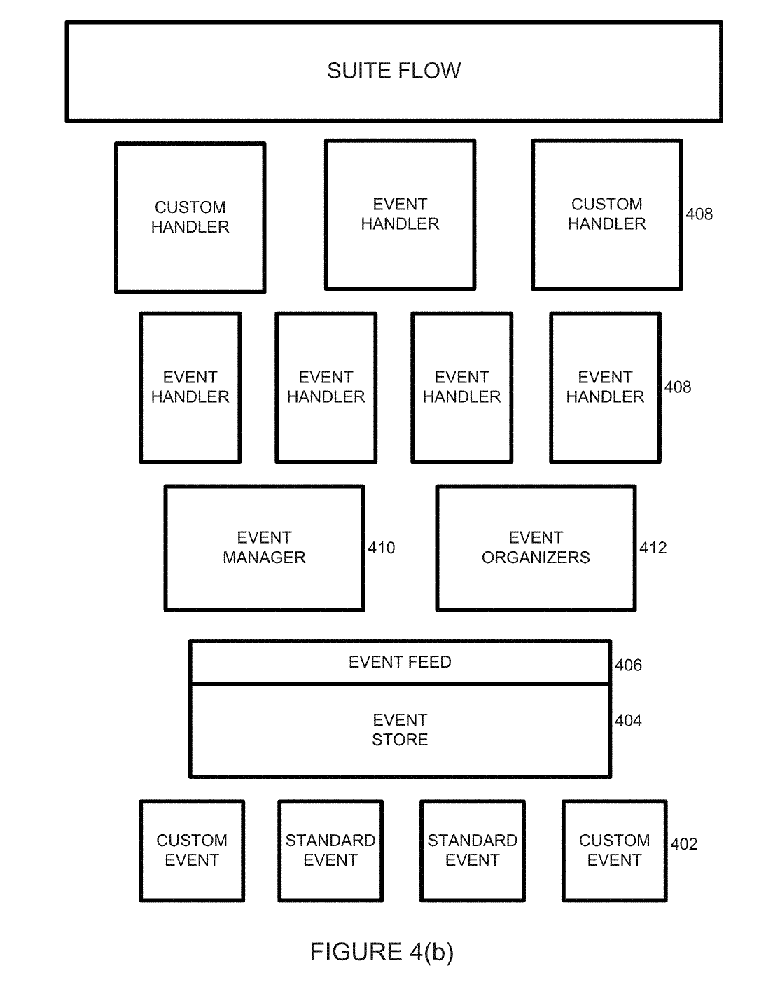

The subscription model used in the publisher/subscriber pattern mitigates this problem since existing subsystems and processes do not need to be altered in order to introduce a new one; instead, new subscriptions and messages are defined in a central location, outside of each subsystem. This pattern addresses the rigidness and complexity of multi-subsystem integrations that require complex communications (such as simplex and duplex) among the subsystems or modules. The pattern is based (at least in part) on a subscription model, where the senders of messages do not send them directly to specific receivers. Instead, senders publish messages that are then recognized by one or more receivers based on a subscription and on a message format that was previously defined. As shown in FIG. 4(a), if sender S1 publishes a message M1 and receiver R1 is subscribed to messages from S1 (and/or to messages having the characteristics of M1), then message M1 will be recognized and processed by R1 without S1 having to know the identity or details of R1.

In some embodiments of the inventive system and methods, this pattern or messaging protocol provides one or more of the following advantages:
a Low coupling: A publisher or sender is not coupled to a subscriber since it doesn't need to know their identities. The communication between them is purely based on a message “contract” and subscriptions;
Flexibility: Since subsystems do not need to know the details of others, subsystem boundaries can be clearly defined by contracts and subscriptions. As a consequence, communication paths and message flows can easily be modified at runtime without needing to alter any subsystem's functionality; and
Scalability: The pattern provides the opportunity to scale horizontally since multiple subsystems can be replicated to handle messages sent by publishers. As a result, the effort to coordinate multiple receivers to handle messages of the same type in a system is relatively low.

FIG. 4(b) is a diagram illustrating aspects of a system, process, method, operation, or function for automating certain business processes associated with order management or order processing, and that may be used when implementing an embodiment of the invention. As shown in the figure, in some embodiments the inventive system and methods may include the following sub-systems, modules, elements, components, processes, functions, or operations:

| Element | Description & Purpose | Example | Customization |
|---|---|---|---|
| Business | Business Events are records to | We expect there to be | Ability to register |
| Event(s) | describe an action that occurred | several dozen | and raise Custom |
| (402) | as a result of a business process | predefined events | Event types. |
| | within the platform. They are | available. For example: | Custom Events can |
| | different from Record or User | SalesOrderCreated | be raised via script. |
| | Events that describe technical | SalesOrderLineAdded | |
| | events to a data record (e.g. | PaymentAuthSuccessfull | |
| | “BeforeRecordSave”). Business | PaymentAuthFailed | |
| | events are related to business | | |
| | processes. | | |
| | Business events are light weight | | |
| | and only hold information that a | | |
| | certain type of event occurred. | | |
| | They do not hold the actual object | | |
| | or entity. Instead they hold a | | |
| | reference to the entity. Other | | |
| | fields include time stamp, | | |
| | cause/raising module. Optionally, | | |
| | a user may also add a small | | |
| | JSON message to the payload of | | |
| | the event to hold some additional | | |
| | (unstructured) data (e.g., reason | | |
| | codes, etc.). | | |
| | For order management, there is | | |
| | expected to be 10-30 business | | |
| | events per order during the life | | |
| | cycle of an order. | | |
| Business | The Business Event Store holds | There is only one | not applicable |
| Event | all raised or published events. | instance of an Event | |
| Store | Ideally, the events would be | Store per account. | |
| (404) | persisted indefinitely, but it may | | |
| | be necessary to purge processed | | |
| | events after a certain amount of | | |
| | time. Processed events might be | | |
| | stored for a predetermined period | | |
| | of time, depending upon the | | |
| | account, nature of the event, etc . . . | | |
| Business | The Business Event Feed is a | There is only one | not applicable |
| Event | representation of the | instance of an Event | |
| Feed | unprocessed events. It allows | Feed per account. | |
| (406) | tracking of which event has been | | |
| | delivered to which handler at what | | |
| | time. | | |
| Business | The Business Event | We expect there to be | Ability to register, |
| Event | Handler(s) are the consumers of | several dozen | define and call |
| Handler | events. They include the decision | predefined handlers | Custom Event |
| (408) | and business logic to determine if | available. For example: | Handlers. Handlers |
| | and what a possible reaction | EvaluateSalesOrderForPayment | can be written in |
| | should be for every given event. | | script. |
| | The handlers process each event | EvaluateSalesOrderForFulfillment | |
| | independently. They have access | | |
| | to the reference data and JSON | | |
| | payload of the event and in some | | |
| | cases may retrieve the | | |
| | appropriate business objects to | | |
| | make the correct decisions. | | |
| | Handlers can subscribe to one or | | |
| | more types of events. Much of the | | |
| | complex order management | | |
| | decision engine is implemented | | |
| | inside handlers. | | |
| | Handlers can subscribe to | | |
| | multiple types of events at the | | |
| | same time and a single type of | | |
| | event can be subscribed to by | | |
| | multiple handlers. | | |
| Business | The Business Event Manager is | | not applicable |
| Event | responsible for feeding events | | |
| Manager | into the appropriate handlers as | | |
| (410) | quickly as possible. It monitors | | |
| | the feed and ensures a | | |
| | successful delivery of events. | | |
| Business | The Business Event Organizer is | | not applicable |
| Event | similarly responsible for feeding | | |
| Organizer | events into the handlers as the | | |
| (412) | event manager. The event | | |
| | organizer, however, is designed | | |
| | to feed events on a scheduled | | |
| | fashion in, what is referred to as | | |
| | “waves” in this description. This | | |
| | means that the Event Organizer | | |
| | “wakes up” on schedule, pulls all | | |
| | unprocessed events from the feed | | |
| | and delivers them to the | | |
| | appropriate handlers. Since it is | | |
| | likely that the Event Organizer | | |
| | picks up a larger number of | | |
| | events at once, it also has the | | |
| | ability to filter and sort the events | | |
| | as part of the delivery. | | |

In FIG. 4(b), the elements with labels “Custom Event” and “Standard Event” (identified as elements 402 in the figure) represent event types or categories. An event type defines the metadata of an event; for example, the name of the event and the entity responsible for raising events of the given event type. For example, an event type name can be “Sales Order Created” and the entity that raises “Sales Order Created” events is the “Sales Order”.

A “Standard Event” represents an event type that is part of the core of the system; a standard event type is known to the processing system and such events are triggered/raised by a core process in an application module regardless of the configuration or customization implemented for a specific merchant. In contrast, a “Custom Event” represents an event type that can be defined by a merchant in the system and such events are triggered/raised only within the merchant's account (along with Standard Events). This allows each account/merchant to define Custom Event types in order to model workflows, decisions, processing operations, and interactions that Standard Event types do not adequately cover (such as those which are dependent upon specific aspects of the merchant's business).

A Custom Event is an event type that is configured so that events are raised in a particular module of a data processing application based on a set of rules or conditions defined by a merchant. For example, suppose that a merchant wants to define an approval process within the system so that every Expense Report is required to be reviewed by a manager; once the Expense Report is approved, the Accounting department is notified and that department then orders a transfer of funds. In order to model this flow in the system, the merchant could create the Custom Event type “Expense Report Approved” and then configure the application to raise events of that type once an Expense Report is approved by a manager. The merchant then would have the ability to have this event type subscribed to by a core process (Event Handler) or to create their own custom process (Custom Handler) for the notification and/or issuance of the transfer.

In FIG. 4(b), Event Store 404 represents a data storage element for events that are created in the application. Every event stored in the Event Store is created with a reference to an event type, has a reference to an entity in the system, has date and time, and may have information such as who created the event (e.g., a user, an automated process, etc.). An event can also include a payload with additional information that may be used by the subscribing process when processing the event.

Event Feed 406 represents data storage for information related to an event; every event that is raised/published and stored in the system generates zero or more Event Feed entries. An event generates one Event Feed entry per each active subscription to the event type. An Event can generate zero Event Feed entries if there are no active subscriptions for the given event type. An Event Feed entry is created based on the information regarding the event raised and the subscription associated with that event. Therefore, an Event Feed entry represents an instruction to execute a certain process for a given event that occurred.

The Event Manager(s) 410 and Event Organizer(s) 412 represent the entities responsible for dispatching/routing events. Both may access and operate on Events and Event Feed entries stored in Event Store 404. An Event Feed entry includes information enabling a dispatcher (an Event Manager and/or an Event Organizer) to route the event to the desired process (i.e., to an Event Handler or to a Custom Handler, elements 408). Note that a difference between the operation of Event Manager 410 and Event Organizer 412 is that of how each manages the processing/routing of an event relative to when the event was received. Event Managers 410 dispatch/route events substantially immediately to Event Handlers (i.e., with no application imposed delays); in contrast, Event Organizers 412 operate based on a schedule and may include use of sorting and filtering capabilities before dispatching events to the appropriate Event Handler.

As noted, events are processed by an Event Handler or by a Custom Handler (elements 408 in the figure). An “Event Handler” can be configured with a Subscription to process any event type that is known to the processing system, subject to the constraint that the event relates directly or indirectly to the Object Type that the Event Handler expects to interact with. This constraint also applies to a “Custom Handler” that is defined by (or for) a merchant using the system.

In the case of standard events, the events are triggered/raised by core processes in an application module regardless of the configuration or customization implemented for a specific merchant. In contrast, “Custom Events” are triggered/raised only within the specific merchant's account. Note that in some embodiments, standard event and custom event handlers can handle both standard and custom events, interchangeably (thus, an Event handler can process or respond to both standard and custom events, and a Custom handler can process or respond to both standard and custom events depending upon how a user/merchant sets up the subscriptions between core/custom events and core/custom handlers in their account). This allows each account/merchant to define Custom Events and their associated processing to implement a desired workflow (such as those which are dependent upon specific aspects of the merchant's business or data related to the business). In some embodiments, a merchant may define a Customer Handler in the inventive system by uploading a plugin or code snippet, and the system will then consider that piece of code as part of the system execution for that account/merchant.

As previously noted, an “Event Handler” will expect to handle events concerning a specific type of object in the system (for example, some handlers expect to handle events relating to the Sales Order object type, others expect to handle events relating to the Payment object type). In order to maximize the flexibility in implementing a workflow, in some embodiments, the system may allow a single Handler to be subscribed to multiple Event Types that may or may not be raised in the context of the same object type. In order to provide such flexibility, facilitate configuration of subscriptions and simplify implementation, the inventive system may provide a “context conversion” infrastructure. This infrastructure operates to translate/convert the event context to the correct object type when a handler is subscribed to an event whose source object type is related to (but not the same as) the object type that the handler is designed to handle. For example, a Handler that expects to handle events related to Sales Orders may also be subscribed to events related to a Payment function if the system is configured to implement a “context conversion” between Payments and the Sales Orders they relate to.

In order to minimize collisions between the operations of two or more handlers that are subscribed to a specific event, the inventive system may implement a locking/serialization mechanism that applies to the Event Handler execution; this can be used to ensure that no two Handlers are called simultaneously for the same target/context object. For example, if a “Payment Authorization Verification” handler and a “Fulfillment Availability Processing” handler are both subscribed to a “Sales Order Approval” event, then the system needs to be able to ensure that these two handlers will not be operating simultaneously (i.e., in an overlapping fashion in the sense of the time at which they are invoked or are operating). This is important to ensure that within the handler's custom or standard logic, the verifications and evaluations made before taking action remain valid/stable while an action is being implemented. Note that the decoupling aspects of a system that implements a publisher-subscriber protocol make it more likely that conflicting actions might be attempted some proportion of the time, so a locking mechanism is more relevant than it might be in other systems.

Note that a context conversion process may be required as part of implementing the locking/serialization mechanism to allow the mechanism to correctly serialize the execution of Event Handlers whose target/context object is the same, regardless of the source object where the event was originated. In such a use, no two handler executions would be permitted to operate on the same target object at the same time, regardless of the source object that raised the triggering events. For example, if a “Sales Order Approved” event were raised, and soon afterwards a “Payment Approval” event were raised on a payment that relates to that same sales order (given that there are respective Handlers subscribed to these two events), then these two handlers should not process the event at the same time. Typically, in such a situation, one handler would be made to wait until the other has completed its processing.

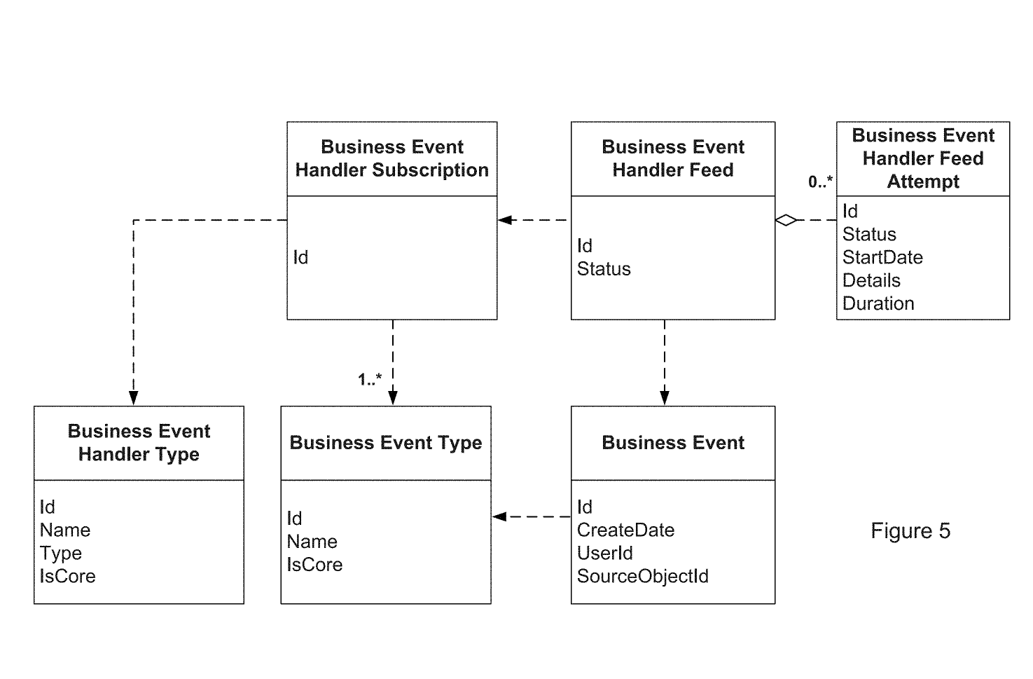

FIG. 5 is an example of a data domain model that may be used as part of implementing an embodiment of the inventive system and methods. The example data domain model includes the following aspects or elements:

Event—this represents the individual event that was raised for a given object. For example, if a sales order is created, then a new entry for event “SalesOrderCreated” is persisted here; this information/data includes the date the event occurred, the user or context in which the event occurred (optional), and the event type and the reference to the object associated with the event that occurred (for example the Sales Order ID);

Event Type—this represents the different types of events that can be raised within the system. For example, “SalesOrderCreated”. Each type of event is assigned an object type (SourceObjectType), which indicates which business object context the event type relates to. For example, “SalesOrderCreated” is an event about a sales order. “PaymentApproved” or “PaymentDeclined” is an event about a payment or payment process;

Handler Type—this represents the different types of handlers or business logic blocks that may be used to process events. Handlers are designed to receive an event or events, execute a specified set or sequence of business logic/business rules and then perform one or more actions. For example, “EvaluateSalesOrderFor Fulfillment” could be a Handler Type. This handler type is then implemented as a business logic block that is operable to evaluate a given sales order for possible fulfillment-related actions.

Depending upon the event(s) and/or logic, the handler may do nothing; or, it may decide that the proper business action is to generate a fulfillment request for a sales order because specified conditions are met (e.g., there is sufficient payment, there is sufficient stock, the purchaser does not have any “red flags”, etc.). Typically, a Handler is designed to apply business rules to a target object (e.g., a business object). For example, a business may have one handler whose purpose is to evaluate sales orders and another handler whose purpose is to evaluate payments. Depending on the target object(s) of the handler, different types of reference data or information may need to be provided to the handler (e.g., a sales order handler requires a sales order ID to apply its business logic, a payment handler requires a payment ID, etc.);

Object Type—this represents the different types of business objects that handlers and/or events can relate to (SourceObjectType in Event Type or TargetObjectType in Handler Type); for example, sales order, payment, customer, shipment, etc;

Subscription—An entity or relationship that links Event Types with Handler Types; this entity can be created or destroyed by a user depending on their business needs. As an example, if a user wants the handler “EvaluateSalesOrderForFulfillment” to react to events of type(s) “SalesOrderCreated”, “LineAdded”, and “SalesOrderUpdated”, then this would be represented by one subscription record that references 1 handler type and 3 event types;

Feed—At the time when an Event is raised and stored, a Feed is generated for that Event. One or multiple Feed entries represent the existing subscriptions of that Event. Since the system tracks every individual event and each of its associated subscriptions for purposes of asynchronous processing, a representation of this is necessary;

Feed Attempt—this represents the processing (or attempted processing) of a given event by a handler that has subscribed to that event; the framework is built for fault tolerance and keeping track of attempts.

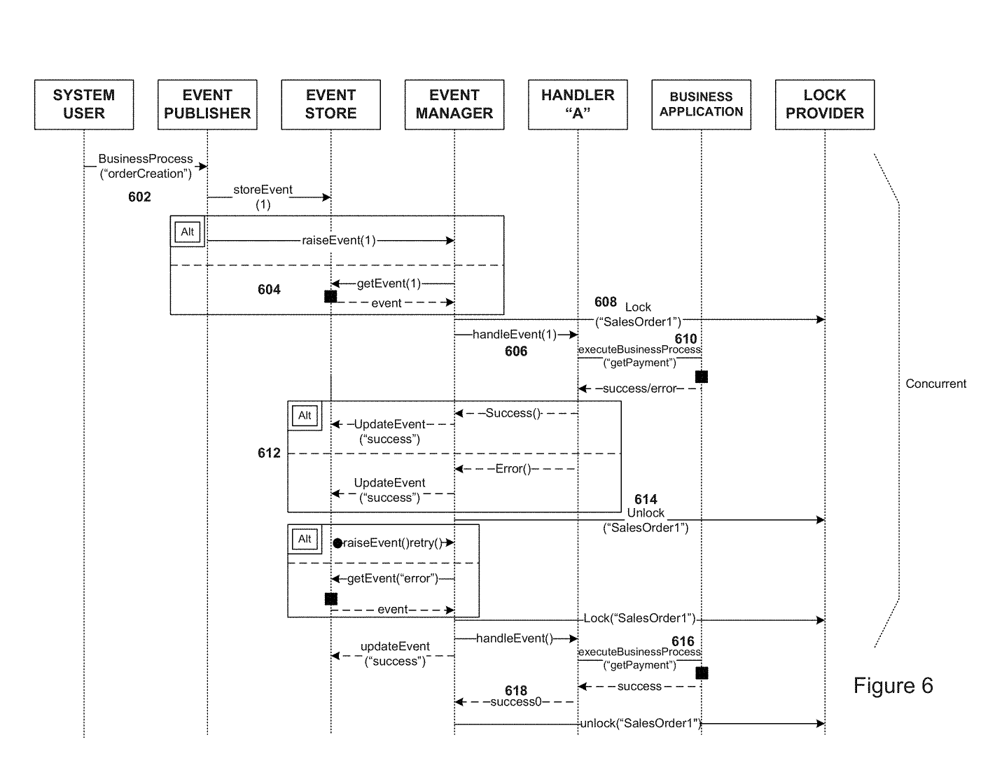

FIG. 6 is a flow chart or flow diagram illustrating a process or event flow that may be implemented in an embodiment of the inventive system and methods. The illustrated example flow represents a process from the point/time at which an event is generated/raised until the Business Events Processing Framework completes by causing the execution of all Event Handlers that were subscribed to that event.

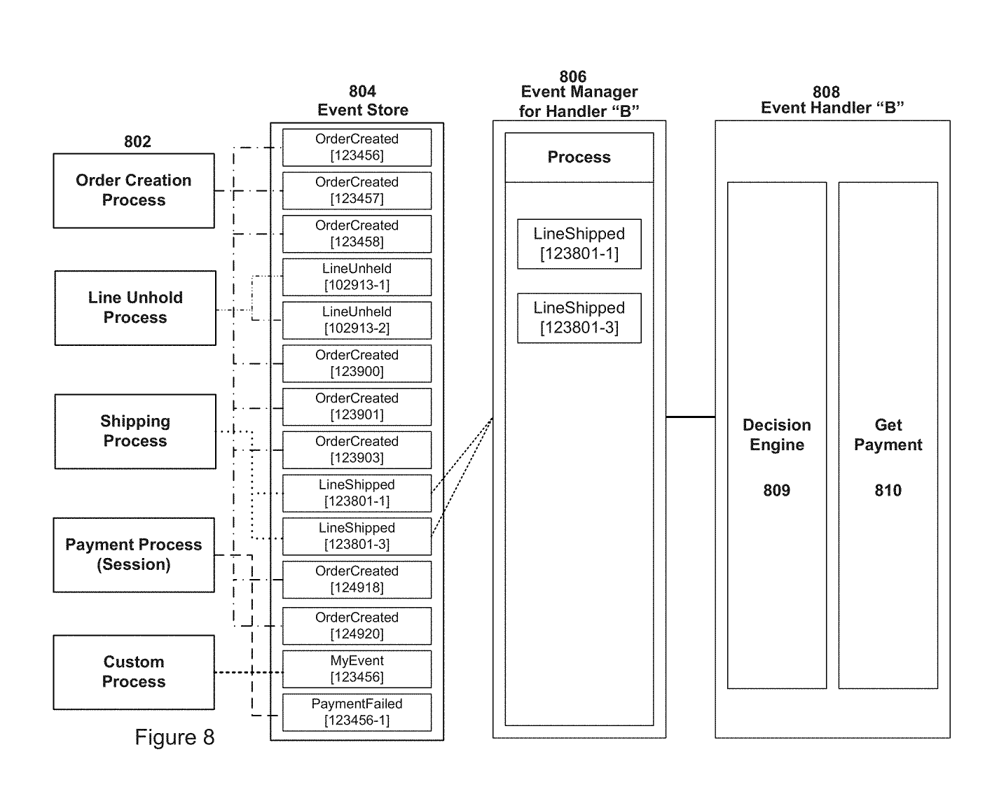

The illustrated example shown in FIG. 6 is based on a merchant workflow that has a single subscription. The subscription ties together the event type “orderCreated” whose context is a sales order object, and the Event Handler “Handler A” in streamed fashion (as will be described further with reference to FIG. 8). Referring to the figure, “Handler A” triggers a business process responsible for capturing a payment for the sales order (“getPayment”). Note that this action also describes a possible way of reducing errors; the flow described could be configured by a merchant that desires to evaluate and potentially capture a payment immediately after a sales order has been created.

In the illustrated example, the following steps/stages may be part of the process flow:

1. The interaction between the System User and Event Publisher (suggested by process stage or step 602 in the figure) refers to a situation where a new sales order is captured in the system and as a result, the event “orderCreated” is generated/raised/published.

The sales order might be captured using any of the channels that the system exposes: a user submitting a form in the backend website, an integration that creates a sales order through a web service, etc. The event is generated/raised within the business logic that is executed in the system when the sales order is created and becomes part of the same transaction.

2. The next stage or step (suggested by 604) relates to how the Event Publisher interacts with the Event Store and the Event Manager.

Once the event has been raised using the Event Publisher component, two actions are performed: the event is stored in the event store (“storeEvent”) and actions are performed so the Event Manager can start event processing (as suggested by the “raiseEvent” task. Raising the event involves creating a Feed Entry for each subscription the event is subscribed to. In this example, a single Feed Entry will be created for “Handler A”.

3. Next, the Event Manager performs an execution of “Handler A” asynchronously (as suggested by 606). Sometime after the event has been raised, the Event Manager consumes the Feed Entry that was created based on the subscription(s) specified in the system for the particular merchant. Before executing “Handler A” the Event Manager tries to acquire a lock on the sales order with ID “SalesOrder1” (as suggested by 608; this is typically done to prevent changes to the data that is being processed). In this example, the lock is acquired so the next step is to execute “Handler A” which performs the business process “getPayment” (as suggested by 610). Unfortunately, an exception is generated while trying to capture the payment (this could be the result of a failure to obtain authorization for the transaction).

Once the execution of the Event Handler tasks are completed (either successfully or with the generation of an error or message), the Event Manager creates or updates a log in the Event Store to reflect the status of the Feed Entry corresponding to the Event raised (as suggested by 612). In this example, the first execution of “Handler A” fails and an error is reported. After this process is completed, the Event Manager requests to unlock the lock that was previously acquired (as suggested by 614), so that other Event Handlers can process the sales order that was previously locked.

4. Next, and depending on the type of exception/error that was generated while executing the Event Handler and the retry policy specified (e.g., as part of the sales order, the Event Handler, or the payment transaction process), the Event Manager may perform a retry of the previously executed task or may apply a different type of retry process. In this example, sometime after the error is reported, the Event Manager tries to execute “Handler A” again (as suggested by 616). The process is the same as before with the difference being that this time the execution succeeds and the Feed Entry is marked as successfully executed (as suggested by 618).

As mentioned, a retailer may have a different desired workflow to deal with payments on sales orders. Some retailers might want to get an authorization once the sales order is placed, whereas other retailers might prefer to perform a capture operation once an order is fulfilled. The inventive business events processing framework permits multiple workflow configurations to be established within a single multi-tenant system; this permits accounts and users to have a high degree of customization while retaining the benefits of a multi-tenant platform.

For example, if a merchant would prefer to authorize payment before fulfillment, they would configure the system so the process “Perform Authorization” is subscribed to the event “Sales Order Created”. Similarly, a merchant that preferred to perform the capture after fulfillment would configure the system to subscribe the event “Sales Order Fulfilled” to the process “Perform Capture”.

Notice that both processes in the example, “Perform Authorization” and “Perform Capture” might be part of the Payments Sub-Module of the system, while the events “Sales Order Created” and “Sales Order Fulfilled” might be raised in the context of the Order Management Sub-Module. Therefore, in this example, the inventive business events framework allows the interaction of two separate modules without forcing them to know about each other or be pre-configured to interact.

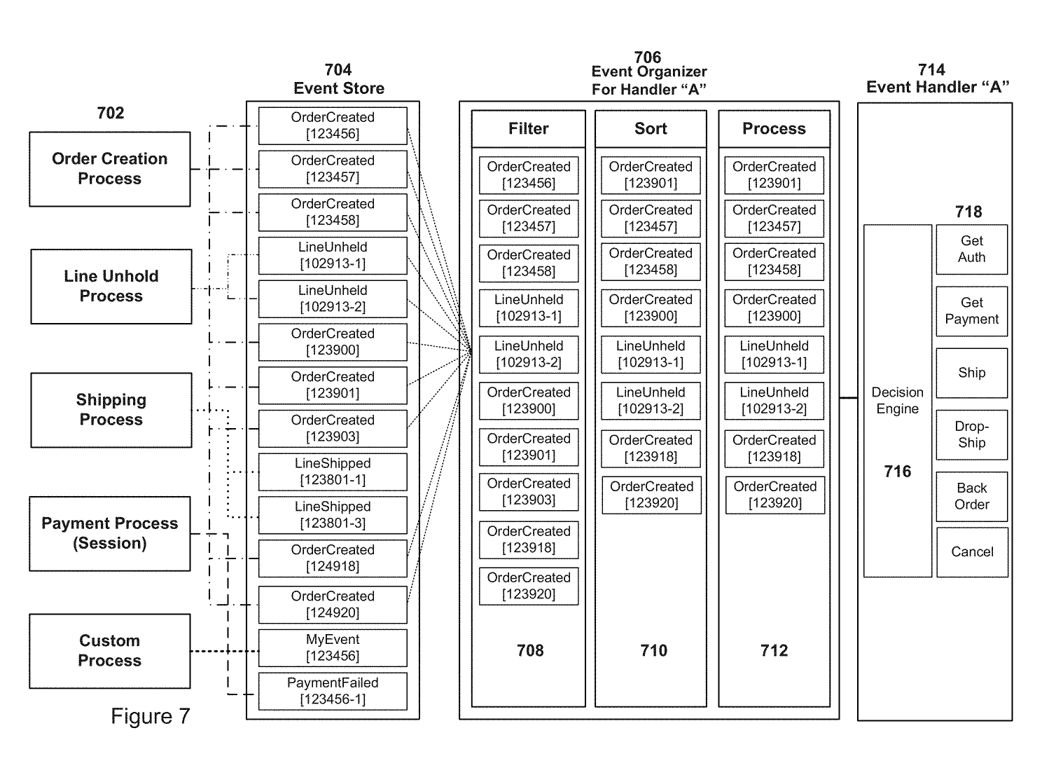

As described herein, in some embodiments of the inventive system and methods, events may be generated or raised by a process or element (such as a user) of the system, with those events then being received by other processes or elements within the system. The received events may operate as a trigger or initiator for a process or element that subscribes to the event type or to the generator of the event. In general, an event may be received and processed substantially immediately upon receipt (the “stream” processing mode described with reference to FIG. 8) or may be processed at a specified time or upon satisfaction of another criteria (such as the number of events, the number of a certain event type, etc.; this is referred to as the “wave” mode of event processing and is described with reference to FIG. 7). Note that depending upon the workflow preferred by a specific merchant, certain events or event types may be processed in accordance with the stream mode, while others may be processed in accordance with the wave mode.

FIG. 7 is a diagram illustrating the process flow of an example of the “wave mode” of events handling that may be implemented in an embodiment of the inventive system and methods. The diagram describes the Event Organizer execution which processes events in scheduled waves (such as in groups that are processed at a specified time, etc.).

The illustrated example is based on a merchant workflow that has a single subscription. The subscription ties together the event types “OrderCreated” and “LineUnheld”, in the context of a sales order object and the use of Event Handler “Handler A”, with event processing being performed in a scheduled fashion. In this example, the scheduled configuration is defined to run daily at 10:00 AM. For this example, assume that the filtering expression specified in the subscription (that is implemented as part of the Event Organizer tasks for Handler A) is to exclude sales orders that are not marked as “express shipment”, and the sorting expression (also implemented as part of the Event Organizer tasks for Handler A) is to sort the orders from oldest to newest sales orders.

In the example shown in the figure, “Handler A” is responsible for evaluating a sales order through the operation of a “Decision Engine”; this may result in potentially triggering multiple business processes that involve operations such as payment processing (“Get Auth” and “Get Payment”), order fulfillment (“Ship”, “Drop-Ship”, “Back-Order”), or order cancellation (“Cancel”).

This example use case includes a situation where multiple business processes (e.g., Order Creation Process, Line Unhold Process, Shipping Process, Payment Process, and a Custom Process) trigger, generate, emit, or otherwise raise events that are stored in the Event Store (as suggested by elements/processes 702 and the paths connecting those elements/processes to Event Store 704).

At some point in time, an instance of the Event Organizer (as suggested by element/process 706) is triggered for a subscription, where the subscription indicates that the event(s) should be processed by “Handler A”. The timing of when the Event Organizer is executed is based on a scheduling configuration defined in a subscription specified in the merchant's account (e.g., 10:00 AM daily).

The Event Organizer for “Handler A” (element or process 706) takes unprocessed events from the Event Store that it is subscribed to and applies certain relevant data processing operations before passing them to the Event Handler for further processing/execution. In this example, it will take unprocessed events of the types “OrderCreated” and “LineUnheld” from the Event Store.

In this example, after accessing the events, a first operation is to filter the event set based on a predefined filtering expression specified in the subscription (as suggested by element/process 708). Here, the filtering operation will exclude two events of the set since they are linked to sales orders that are marked as “express shipment” (as suggested by the lighter (washed out) features of those events). Once the filtering operation is completed, the Event Organizer performs a sorting operation (as suggested by element/process 710)—here it sorts the events from oldest to newest and then provides them in order, one by one, to “Handler A” (element/process 714) for further processing, using event processing element/process 712. The event processing flow from the Event Handler is executed until it finishes.

“Handler A” 714 is designed to operate to determine the correct operation to perform on each sales order based on the current state of the sales order and/or other information regarding the merchant (e.g., specific business related data). This determination may be static in simpler scenarios (e.g., send a notification to a customer) and may be dynamic when multiple variables play a part in the decision process (e.g., choosing a proper fulfillment location for a sales order based on an approval and the current inventory levels, determining the amount of a discount to offer a customer based on inventory levels, sales velocity, profit margin, etc.). This decision logic is represented by the “Decision Engine” element/process 716 that is part of Event Handler 714. The decision logic or process may trigger multiple business processes 718 that are part of the user/merchant's desired workflow for processing an order; these business processes may include one or more of payment processing (“Get Auth” and “Get Payment”), order fulfillment (“Ship”, “Drop-Ship”, “Back-Order”), or order cancellation (“Cancel”).

Event Organizer 706 provides a mechanism to model a complex business workflow that deals with both “regular” and “express shipment” sales orders. The example described with reference to FIG. 7 illustrates how a merchant would perform fulfillment for regular/normal sales orders. Note that in order to model the workflow for express shipment sales orders, a merchant could create a new subscription to be implemented by “Handler A” that included a filtering step based on identifying express shipment sales orders, and scheduled to be executed at 4:00 PM daily. The new subscription would allow the system to process express shipment sales orders daily before the warehouses close. As a consequence, express shipment sales orders could be fulfilled within the same day that they were created, instead of being executed the following day at 10:00 AM.

The Event Organizer also provides a mechanism to connect or “chain” together subsequent Event Organizers, such that the next wave of processing begins as soon as the current one is completed. This capability may be important when there is a need for coordination between processes, and especially when the filtering or sorting of Handler executions in a latter wave depend on the outcomes/effects of the Handlers in an earlier wave. For example, it may be important that a wave of Fulfillment Processing handlers be called as soon as possible after completion of the previous Authorization Processing handlers, so that the highest-priority instances of the successfully authorized sales orders could be processed first in the Fulfillment Processing. This would maximize the likelihood of inventory being allocated to the high-priority orders.

The Event Organizer includes or uses a supporting mechanism that provides for organizer/wave isolation; this is used to ensure that there will not be more than one Event Organizer instance running at the same time for the same Handler Type. This is important to prevent, because if this occurred, it would effectively invalidate some of the benefits of the filtering and sorting mechanisms implemented in wave processing. For example, if one Event Organizer/wave subscription were configured to handle Express shipments in order to ensure these had first priority, and another less-specific wave were to start up at the same time, then the handlers executing in the less-specific wave could end up allocating or reserving inventory units that were intended to be allocated to the express shipments.

This improved capability of a merchant's business operations is enabled by the ability of embodiments of the inventive system and methods to provide merchants with a tool to control aspects of the order processing task at a finer level of granularity than conventional systems, which typically provide a static set of tasks that are fixed for a predefined workflow. For example:
In conventional multi-tenant systems, the order processing flow is normally predefined at the system level and allows only minor variations based on preferences at the merchant level;
   However, often merchants require more sophisticated logic than the one provided by the predefined workflow with preferences in order to efficiently operate their business;
   For example, the Payment processing function that is part of order processing is a complex process that may be used in multiple ways by customers—modelling a system with predefined workflows and preferences in order to support all of the peculiarities of each vertical and customer would be a very complex task and would in most cases not be available as part of conventional order processing systems.
      In contrast, and with respect to payment processing, embodiments of the inventive system permit a high degree of flexibility since each merchant is able to create granular-level subscriptions to the event flow for payment processing. For example, a merchant would be able to trigger payment processing after a Sales Order has been approved (event SalesOrderApproved) or after the fulfillment process has been completed (event SalesOrderShipped). Similarly, a merchant could trigger custom events as part of the order processing workflow and subscribe them to payment processing.

FIG. 8 is a diagram illustrating the process flow of an example of the “streamed” mode of events handling that may be implemented in an embodiment of the inventive system and methods. The diagram describes the interaction between business processes, Event Store, Event Manager and Event Handlers to implement events processing in a streamed mode (i.e., as soon as received/identified mode).

The illustrated example use case is based on a merchant workflow that has a single subscription. The subscription ties together the event type “LineShipped” and the Event Handler “Handler B”. Event processing is being performed in streamed fashion.

“Handler B” is responsible for evaluating a sales order through the “Decision Engine” and potentially triggering a business process responsible of capturing a payment for the sales order (“Get Payment”).

This example use case includes a situation where multiple business processes 802 (e.g., Order Creation Process, Line Unhold Process, Shipping Process, Payment Process, and a Custom Process) trigger, emit, generate, or otherwise raise events which are stored in the Event Store (as suggested by elements/processes 802 and the paths connecting those elements/processes to Event Store 804).

At some point in time, an instance of the Event Manager (as suggested by element/process 806) is executed, and based on the active subscriptions and the existing events in the Event Store, the Event Manager determines that the event(s) should be processed by “Handler B”.

As suggested by the Figure, Event Manager 806 will cause the execution of “Handler B” twice on the same record instance; this is because there are two events in the Event Store, “LineShipped [123801-1]” and “LineShipped[123801-3]” that have the same record identifier “123801”. Note that this means that “Handler B” should be designed in a way that it performs an idempotent operation (where an Event Handler that is designed to perform an idempotent operation is one that produces the same results, whether called once or multiple times under the same conditions).

Since the primary responsibility of “Handler B” is obtaining payment from the buyer for a sales order, it is important that the Event Handler is designed to be idempotent, and consequently that multiple executions do not affect the total amount captured from a buyer in situations in which there are the same conditions (with regards to one or more parameters or fields) on the sales order. In FIG. 8, the idempotent capability of “Event Handler B” 808 is represented by the “Decision Engine” 809 process inside the Event Handler. The function or operation of “Decision Engine” 809 is to evaluate a sales order and determine if a new capture operation is required. The process executed in obtaining a payment is represented by the function or operation “Get Payment” 810, which is also inside Event Handler B 808.

The “Decision Engine” 809 should evaluate the record instance that the event is pointing to and determine if it should run any operation. The “Decision Engine” 809 can check properties of the record instance such as status, previous payments, credit card information or other business flow conditions. The “Decision Engine” represents a method or function that checks business rules to determine if an action should be taken. Generally, it can be provided by the system or can be customized by each merchant to meet their more sophisticated business requirements.

Note that due to the asynchronous aspects and behavior of the described framework for event processing, during the time between an event being raised and the event being processed, the target record may have changed. This represents a possible source of inconsistency that may be challenging for some of the business operations that an Event Handler is responsible for executing. In those cases, the business operations should be designed to be idempotent. This may be achieved by having an Event Handler always check the state of the system and record instance to determine if the actions of the Event Handler should be applied. There are also techniques such as event deduplication that might be used for this function, although they may cause problems in implementing other aspects of the proposed system.

Note also that the inventive business events processing framework is agnostic with regards to changes in the state of entities and records that are processed in Event Handlers; this provides simplicity and the flexibility to let each Event Handler decide how to deal with any changes in data, and enables the decision process implemented by the Event Handler to be driven by the current state of the data values.

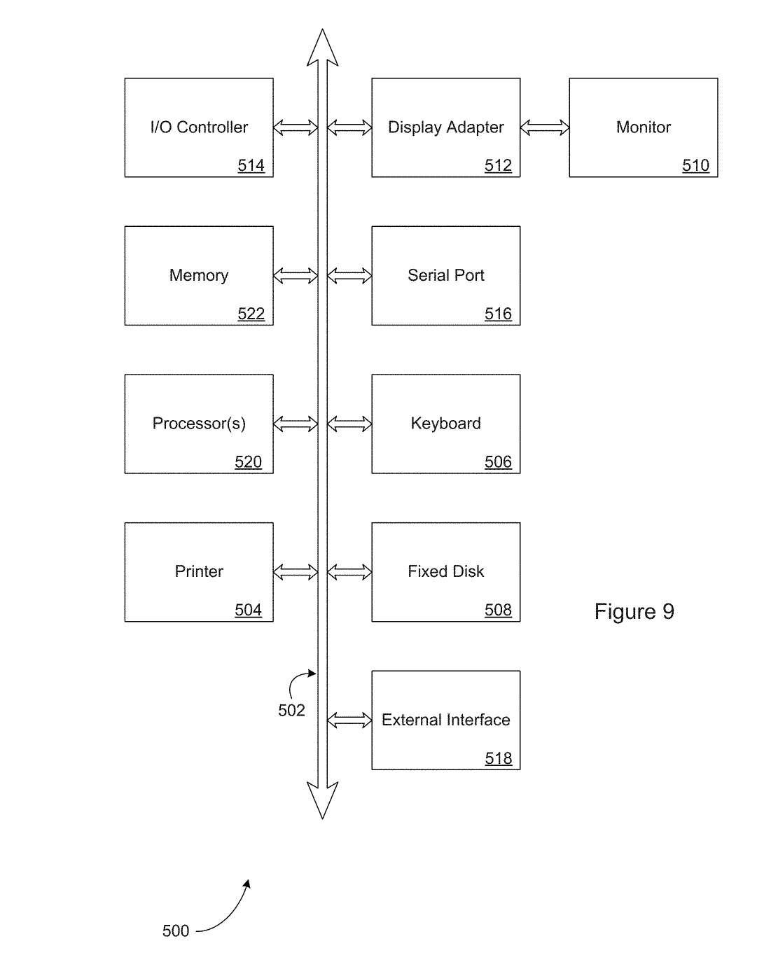

In accordance with one embodiment of the invention, the system, apparatus, methods, processes, functions, and/or operations for enabling efficient configuration and presentation of a user interface to a user based on the user's previous behavior may be wholly or partially implemented in the form of a set of instructions executed by one or more programmed computer processors such as a central processing unit (CPU) or microprocessor. Such processors may be incorporated in an apparatus, server, client or other computing or data processing device operated by, or in communication with, other components of the system. As an example, FIG. 9 is a diagram illustrating elements or components that may be present in a computer device or system 900 configured to implement a method, process, function, or operation in accordance with an embodiment of the invention. The subsystems shown in FIG. 9 are interconnected via a system bus 902. Additional subsystems include a printer 904, a keyboard 906, a fixed disk 908, and a monitor 910, which is coupled to a display adapter 912. Peripherals and input/output (I/O) devices, which couple to an I/O controller 914, can be connected to the computer system by any number of means known in the art, such as a serial port 916. For example, the serial port 916 or an external interface 918 can be utilized to connect the computer device 900 to further devices and/or systems not shown in FIG. 9 including a wide area network such as the Internet, a mouse input device, and/or a scanner. The interconnection via the system bus 902 allows one or more processors 920 to communicate with each subsystem and to control the execution of instructions that may be stored in a system memory 922 and/or the fixed disk 908, as well as the exchange of information between subsystems. The system memory 922 and/or the fixed disk 908 may embody a tangible computer-readable medium.

Embodiments of the inventive system and methods implement elements and/or processes that provide one or more of the following benefits, features, or advantages:

Reactive/Decoupled/Async Processing—The ability to execute business logic in an asynchronous fashion, decoupled from the originating/initiating process, hence decreasing the load on the interactive process and increasing the perceived performance for the user. Additionally, allows for delayed or scheduled processing;

Automated Decision Engine—Encapsulating decision processes and logic and extracting it from the interactive process. Allows automated decisions to be made in the background;

Predictability and Audit—Consistent behavior by system processes, hence predictable outcomes for the user. Provides an audit of the automated decisions taken;

Processing in Streams or Waves—Ability to process events in constant streams (as they happen, but still asynchronous) or in waves (based on certain times, schedules, conditions). When processing in waves, full control of the order of execution, process isolation, and process chains are enabled;

Fault Tolerant—Strong error handling and error recovery features, allowing for high volume processing in the background without user interaction;

Scalable—Architecture allows for complex and expensive processes to be decoupled from synchronous flows and transferred to the backend. This increases the scalability of the overall application, since synchronous flows such as web requests or web services calls become faster.

The proposed solution is also designed to be able to scale horizontally by applying multiple machines that execute the business events processing framework;

Intra-System Communication Model—Provides ability for sub-systems to exchange light-weight messages between each other through the back-end. This becomes extremely important in order to create distributed systems with low coupling, high volume, and satisfactory fault tolerance;

Customizable business processes and events—Ability to create custom business processes and to create custom events. This provides a merchant with the flexibility to extend the system functionality by adding new flows and new processes; and

Configurability of business flows—Provides the ability for merchants in a multi-tenant environment to customize business processes performed across different entities and records, using a relatively simple subscription model. The inventive solution allows merchants to create their own custom flows or to modify core flows to suit their business and operational needs.

Note that users can create or modify business flows by changing subscription definitions through the UI, as opposed to conventional systems where new development is required to accomplish the same result.

Another feature of the inventive business events framework is that of allowing users to specify an error handling strategy, to be applied in case an event cannot be processed or an error occurs while it's being processed. For example, given a subscription between a process and an event, when an error occurs in the process during event processing, the business events framework will access the error handing strategy defined in the subscription and react accordingly. Note that a strategy may vary depending on a merchant's preferences; examples of possible error handling strategies include the following:

Retry processing the event immediately (or based on a schedule) up to a maximum number of times;

Discard/Cancel processing the event;

Send a notification to users interested in the error or failed process; or

Trigger another process or function in response.

Therefore, when merchants specify a subscription in the system, the following parameters may be required:

Reference to a process or system function;

Description or list of a set of events that will trigger the process or system function specified;

Type of subscription; stream or scheduled;

Time component; and

Error handling strategy.

If the subscription is scheduled, then it may also need to specify the following parameters:

Scheduling details, such as starting date, end date, and recurring pattern;

Filtering expression to be applied by the Event Organizer to the event set; and

Sorting expression to be applied by the Event Organizer to the event set.

In general, by providing a mechanism for decoupling events occurring within a data processing system from the business logic (expressed as rules, conditions, workflow descriptions, etc.), embodiments of the inventive system and methods provide benefits to both users and administrators of a single or multi-tenant data processing platform. These benefits may be expressed in terms of the scalability and customization that can be provided to users and the improved insight into resource allocation provided to a platform administrator. For example:
The inventive system and methods allows multiple business processes to be independently defined by a tenant of a multi-tenant system; such systems need to be flexible enough to enable each tenant to establish processes that fulfill their workflow needs. Embodiments of the invention provide a flexible solution to permit tenants to configure custom business flows within a single system by using an approach based on a subscription model between business events and business processes;
The inventive system and methods also address complex issues that can arise in attempting to scale a multi-tenant system in response to specific tenant needs. Note that in conventional multi-tenant systems, scalability is typically addressed at a system level or in terms of groups of tenants by scaling vertically (such as by increasing the power of servers), or horizontally (such as by replication of the system in multiple platforms). Although this type of scalability solution can be effective in some scenarios, in situations where some individual tenants need to scale more than others and at a particular point in time, achieving efficient scaling for a particular tenant becomes difficult with regards to the predictability of the scalability improvement of the system for the tenant. In contrast, the invention sets clear boundaries between tenant processes by using the described Event Handlers; this provides a mechanism to more easily and reliably scale individual components that contain business processes in case of a peak in the volume of business events raised by a particular tenant;
Business Events can be used as a measure of the load placed on a system by a particular tenant at a point in time. Because of this, an embodiment of the inventive system may implement a dynamic scalability improvement process that monitors business events for each tenant and dynamically adjusts the throughput and capacity of the system for each tenant depending on the load of events and the projection of future load;
   This capability could be implemented by monitoring the events broadcast and/or processed by one or more nodes/process steps in a business workflow, or by determining a different metric characterizing the load or relative load on certain aspects of a data processing platform. For example, if it is observed that a workflow for processing an order from placement through a certain fulfillment stage typically uses up a larger fraction of the data processing resources than any other single process or combination of typical processes in a workflow, then the number of order placement events generated may be a suitable metric or proxy for characterizing the overall demand for resources. Similarly, if the number of events generated by a specific process fall above or below some threshold, then processing resources might be (re)allocated to address the situation and reduce or eliminate the cause of exceeding or falling under the threshold value;
Note that embodiments of the invention also provide a scalable and flexible solution to controlling business workflow processes within a single tenant system; in a single tenant system, the inventive business events framework can act as a coordinator between business events and business processes, decoupling business processes in the system and adding the flexibility to better control business workflows; and
In business data processing systems that implement one or more business applications (such as ERP, CRM, HR, financials, etc.), changes in the state of a record or entity normally require that other components or subsystems be notified in order to initiate some sort of processing. For example, after a user creates a sales order through an eCommerce site, multiple processes might need to be triggered for the processing of that order. A subsystem responsible for accounting might also be triggered since it may need to evaluate the new state of the system and act accordingly (such as by creating one or more accounting transactions). Similarly, subsystems responsible for managing inventory, customer notifications, or revenue recognition might also be involved;
   However, dealing with state changes and communication of those changes through multiple subsystems usually involves a relatively complex communication solution, which results in subsystems tending to become tightly coupled; but, by tightly coupling subsystems, a change in a single subsystem can be a source of error since it can impact others. This is a disadvantage of creating an environment in which tighter coupling is necessary or results from evolution of the system. In contrast, the embodiments of the inventive system and methods utilize a mechanism that avoids this tight coupling of subsystems, while fulfilling the need to enable the triggering of other processes as a result of state changes in the system. The described use of business events with a publisher/subscriber protocol provides benefits in terms of how subsystems communicate because among other aspects, a subsystem that originated a data change in the system is agnostic with respect to the resulting processes that might be started as a consequence of the data change.

As described herein, implementing order life cycle automation through a flexible publish/subscribe pattern, where business events are triggered and subscribed to by business processes, allows for an extremely flexible and merchant specific design of the business processes. This approach functions to provide one or more of the following operational benefits:
decouples triggers (events) and processes (handlers);
provides an ability for merchants to change how processes are triggered on demand through configuration of a subscription to published events;
allows multi-branch decision trees with or without interdependencies, thereby facilitating more complex business logic;
provides timing control for the execution of a triggered process (e.g., immediately, delayed, or at a certain point in time);
provides an ability to group triggered processes together (e.g., warehouse wave mode of processing); and
provides the ability to use pattern detection, machine learning, etc. to enable advanced decision making logic.

Note that order life cycle automation is implemented using state-machines/state-automation in conventional order management platforms. However, this approach has inherent limitations; by using a publish/subscribe pattern instead, embodiments of the inventive system and methods provide significant benefits in terms of system configurability, flexibility, and allowable complexity at the tenant/account level. The inventive system provides the ability to fully abstract and decouple the business processes from the workflow events, and the ability for a user to configure the relationships between such events and processes. In addition, with business events based processing (such as that enabled by the invention), there are no limits on the complexity of relationships between events and processes; any number of events can be subscribed to by any number of processes. There is no hierarchy or cardinality enforced on the order or relationships between executable processes or functions. As a result, the implemented “map” of possible processing flows can be significantly more complex than for a conventional workflow engine. This is because the ability to fully configure and implement the “map” of possible/desired processing flows is not practical with a state machine or other conventional methodology.

Possible uses cases for the inventive methods outside of order management include, but are not limited to revenue recognition, billing, payments and HCM areas, as these business areas frequently have business processes that need to be triggered by decoupled events on invoices, purchase orders, credit card settlements, and employee events. For example, when a credit card payment is declined, a “declined event” may be generated and subscribed to by a “reattempt process”, which may be configured to vary based on criteria specified by a merchant.

Additional features of the inventive business events framework allow a user to specify a time component in a subscription so that a reattempt process is triggered several days after the event has been generated. This may be useful in automatically causing a process to be attempted without requiring further user action; for example, a retry of a process to obtain credit card authorization, a process that cannot be completed until a specified time after a specific event, etc.

Note that the benefits provided by embodiments of the inventive system and methods when implemented as part of a multi-tenant business data processing platform include, but are not limited to:

(1) The physical computing resources that process the events do not need to be in the same system. It is possible to “outsource” the processes to other services in the cloud. This framework allows merchants to combine processes from distinct providers into a single, coordinated network;
(2) Computing resources can be allocated to different processes on demand. Tenants can pool processing resources that are decoupled from any user interaction resources;
(3) Using a publish-subscribe paradigm allows each tenant to have completely distinct business processes, order flows, maps, etc.; and
(4) By applying machine learning/event pattern detection, the system is able to detect trends across groups of merchants. For example, if “Credit Card Declined” events suddenly appear at much higher rate across multiple merchants, then a business or infrastructure alert may be sent out to help determine the cause.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, JavaScript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

That which is claimed is:

1. A system for automating the execution of a business process, comprising:
a computer-implemented process to permit a user to specify the business process, and one or more business objects that are associated with the business process;
a computer-implemented process to permit the user to specify an event that is to be generated by the business process upon the detection and/or processing of one or more of the one or more business objects;
a computer-implemented process to permit the user to specify a second business process that is to be configured to detect the generated event; and
a computer-implemented process to permit the user to specify an action or inaction by the second business process in response to the detected event.

2. The system of claim 1, further comprising a computer-implemented process to permit the user to create an association between the business process and a second one of a business process or a business sub-process.

3. The system of claim 1, further comprising a computer-implemented process to permit the user to specify one or more rules, conditions, or constraints that determine whether the event is generated by the business process.

4. The system of claim 3, wherein the one or more rules, conditions, or constraints that determine whether the event is generated by the business process is a function of the value of, or a combination of values of business related data.

5. The system of claim 4, wherein the business related data includes one or more of ERP, CRM, HR, eCommerce, or financial data related to a business.

6. The system of claim 1, wherein the business objects may include one or more of a data field, a business related function, a business related process or a sub-process.

7. The system of claim 1, further comprising a computer-implemented process to permit the user to specify one or more rules, conditions, or constraints that determine the action or inaction by the second business process in response to the detected event.

8. The system of claim 7, wherein the one or more rules, conditions, or constraints that determine the action or inaction by the second business process is a function of the value of, or a combination of values of business related data.

9. The system of claim 8, wherein the business related data includes one or more of ERP, CRM, HR, eCommerce, or financial data related to a business.

10. A multi-tenant business data processing system, comprising:
one or more business related data processing applications installed in the system and accessible by a plurality of tenants of the multi-tenant data processing system;
a data storage element coupled to the one or more business related data processing applications;
a processor programmed with a set of instructions, wherein when executed by the processor, the instructions cause the system to
permit a user to specify a business process, and one or more business objects that are associated with the business process;
permit the user to specify an event that is to be generated by the business process upon the detection and/or processing of one or more of the one or more business objects;
permit the user to specify a second business process that is to be configured to detect the generated event; and
permit the user to specify an action or inaction by the second business process in response to the detected event.

11. The system of claim 10, wherein the one or more business related data processing applications installed in the system include one or more of financial, enterprise resource planning (ERP), customer relationship management (CRM) or eCommerce related applications.

12. The system of claim 10, further comprising a set of instructions, that when executed by the processor cause the system to permit the user to create an association between the business process and a second one of a business process or a business sub-process.

13. The system of claim 10, further comprising a set of instructions, that when executed by the processor cause the system to permit the user to specify one or more rules, conditions, or constraints that determine whether the event is generated by the business process.

14. The system of claim 13, wherein the one or more rules, conditions, or constraints that determine whether the event is generated by the business process is a function of the value of, or a combination of values of business related data stored in the data storage element.

15. The system of claim 14, wherein the business related data includes one or more of ERP, CRM, HR, eCommerce, or financial data related to a business.

16. The system of claim 10, wherein the business objects may include one or more of a data field, a business related function, a business related process or a sub-process.

17. The system of claim 10, further comprising a set of instructions, that when executed by the processor cause the system to permit the user to specify one or more rules, conditions, or constraints that determine the action or inaction by the second business process in response to the detected event.

18. The system of claim 17, wherein the one or more rules, conditions, or constraints that determine the action or inaction by the second business process is a function of the value of, or a combination of values of business related data stored in the data storage element.

19. The system of claim 18, wherein the business related data includes one or more of ERP, CRM, HR, eCommerce, or financial data related to a business.
